(19) United States
(12) Patent Application Publication
(10) Pub. No.: US 2012/0286702 A1
(43) Pub. Date: Nov. 15, 2012

(54) APPARATUS AND METHOD FOR ENERGY STORAGE WITH RELATIVISTIC PARTICLE ACCELERATION

(76) Inventor: Gaurav Bazaz, Edgewater, NJ (US)

(21) Appl. No.: 13/468,027

(22) Filed: May 9, 2012

Related U.S. Application Data
(60) Provisional application No. 61/484,009, filed on May 9, 2011.

(51) Int. Cl. H05H 7/04; H05H 7/18

(52) U.S. Cl. 315/501; 315/506

(57) ABSTRACT

An energy storage device is proposed that utilizes acceleration of particles to near relativistic velocities to store energy in the kinetic energy of accelerated particles. Designs and models are provided for a commercially feasible device that implements the concept. The device allows tremendous performance capabilities across many parameters including energy density. Multiple innovations are also proposed for methods to reconvert the kinetic energy of accelerated particles back to electricity. In addition, certain innovations are proposed for accelerated particle beam control, beam particle designs and beam confinement rings. The device is different from existing particle collider storage rings in that it maximizes total beam energy, not energy per particle by accelerating particles to velocities substantially less than the speed of light. In addition, it includes innovations to meet the requirements of the commercial market with specific applications in markets such as grid level storage and energy storage for vehicles.

### RELATED APPLICATION

This application claims the benefit of priority to U.S. Provisional Application 61/484,009 filed 9 May 2011, the entire disclosure of which is incorporated herein by reference.

### FIELD OF THE INVENTION

The present invention relates to storage of energy in very large quantities utilizing the kinetic energy of particles accelerated to near relativistic velocities but substantially less than the speed of light which permits reduction in cost and size of the device while storing large amounts of energy. In addition the invention concerns the design of particle beams with much larger beam mass than is usually observed in particle beams in applications such as particle colliders. Lastly, the invention proposes various methods for reconversion of kinetic energy of accelerated particles to electricity with high levels of efficiency and at economical costs.

### BACKGROUND

Current models for energy storage primarily rely on storage in static energy fields. Most common energy storage devices such as batteries use various types of designs but all eventually rely on separation of charges thereby creating an electric field or electromotive force between the positively and negatively charged regions wherein the energy is stored. Some other methods store energy in chemical bonds of substances while some others use mechanical set ups to store energy. Examples of Chemical Energy storage include Hydrogen Fuel as well as Fossil Fuels such as Gasoline. Mechanical energy storage is seen in Flywheels, Compressed Air Storage as well as Pumped Hydro.

All current models suffer from one of two, or both, problems—High energy density options, such as fossil fuels, are environmentally destructive and can't feasibly be manufactured synthetically in an economical way. On the other hand, systems that can be produced synthetically and manufactured economically generally have very low energy densities (Joules/kg or Joules/m³) making them unviable for various commercial requirements. Besides, the cost in terms of Dollars per Kilo-watt-hour ($/kwhr) is usually too high to be practical.

Present invention offers a new model of energy storage that can potentially store energy with enormous energy densities, comparable to if not much higher than fossil fuels, while also being environmentally friendly, easy to manufacture, efficient, versatile, scalable and highly economical.

### SUMMARY OF INVENTION

The model of the present invention relies on accelerating particles to very high velocities within a confined enclosure and holding them at the high velocity in a vacuum chamber. In one embodiment, the particles are charged particles such as protons or electrons, which are accelerated using an accelerator within a circular ring vacuum cavity to very high velocities, approaching the speed of light, though considerably less than the velocities seen in particle colliders such as LHC in Geneva. As particles are accelerated, their kinetic energy (KE) increases, and is stored in their continuous motion in a closed loop. The particles are held within the confined enclosure of the vacuum rings by the application of appropriate magnetic fields and/or electric fields. Charged particles moving in the xy-plane can be held in a fixed circular path without loss of energy when a magnetic field is applied along the z-axis. Similarly, a charged particle beam can be bent in its path by the application of an electric field perpendicular to the beam path, with very limited or no loss of energy. A good analogy to the present invention is the model of particle colliders such as the Tevatron at Fermilab. However, present invention doesn't accelerate individual particles to velocities anywhere near the velocities such facilities accelerate particles to and therefore is much smaller and less expensive. When energy is required to be extracted to do work (eg: drive a motor), the particles are drawn from the storage chamber and shot into an energy reconversion chamber where the kinetic energy (KE) of the particles is converted back to electricity. Various methods can be utilized to convert KE back to electricity, some of which are proposed in this invention. Therefore, in summary, the system draws energy from an external source and stores it in the kinetic energy of highly accelerated particles. The particles retain the energy as they circle within a confining chamber which has close to complete vacuum. This energy stored as kinetic energy in the accelerated particles is then reconverted to potential energy (such as electricity) by a reconversion system, after which energy is drawn from the system to power an external device. The primary innovations in this invention are in the concept of using accelerator storage rings as commercial energy storage devices, in the concept of maximizing beam energy not particle energy by accelerating particles to high, but not extremely high velocities so as to optimize the size, cost, total stored energy, energy density and energy losses in the device, in certain proposed beam designs, in certain proposed beam path designs, in overall device and system design, in certain safety methods, in certain proposed component designs and in certain proposed energy reconversion methods.

The specific particle accelerated could be one of many different types of particles depending on the requirements, efficacy and efficiency for the particular requirement. In one embodiment, the accelerated particle is a proton and the energy is stored by accelerating a very large number of protons to very high velocities. The energy stored in an accelerated particle at very high velocities is given by the relativistic kinetic energy formula:

$$E = m {c}^{2} ( \frac{1}{\sqrt{1 - {( v / c )}^{2}}} - 1 )$$

where,
E=energy
m=mass of particle=1.6×10⁻²⁷ kg
c=velocity of light=3×10⁸ m/s
v=velocity of particle—assume in this example to be 0.9 c (2.7×10⁸ m/s)
Therefore, a single proton accelerated to 0.9 c would have energy:

E=(1.6*10⁻²⁷)(3*10⁸)²(1/sqrt(1−0.81)−1)=6.14×10⁻¹⁰ J
Assuming we need to build a device which can store 1 MWHr, we will need to store 3.6×10⁹ Joules.
This would require the following number of protons:

(3.6×10⁹)/(6.14×10⁻¹⁰)=5.8×10¹⁸ protons. This is approximately 10 micrograms (10⁻⁵ grams) of protons.

The particle is accelerated using one of many possible methods such as by passing it through an accelerating electric (or magnetic) field, alternating electric of magnetic fields or using an RF cavity. When the charged particle enters the field, it has a certain velocity. The accelerator component pushes the charged particles out with a much higher velocity increasing the kinetic energy of the particle. Thereby, the potential energy of the electric field, drawn from the external power source which is supplying the energy to the accelerator component, is stored as the kinetic energy of the accelerated particle. The particle (or groups of particles) is repeatedly run through the accelerator component till it achieves a very high velocity beyond which it cannot be accelerated given the limitations of the equipment (eg: the strength of the confining magnetic field, size of device etc.). Once the particle reaches the peak velocity it is sent over to the storage ring where it circles the ring continuously with minimum loss of energy until it is pulled out to re-convert its kinetic energy into potential energy, such as electricity. The reconversion of kinetic energy (KE) to electricity can be achieved in one of many different ways, and some methods are proposed in this invention. One method involves shooting the charged particles into a solution (or lattice) of neutral but highly ionizable particles. As the accelerated particles strike the neutral particles in the reconversion device, they cause them to ionize and an electric field applied across the device causes the opposite charges to collect at opposite ends of the device. This creates an electric potential between the two ends of the device, which can be used to generate electricity using conventional methods. A second method converts the KE of the particles to electricity through direct induction. The charged particle beam is shot into a vacuum cavity similar to the storage ring, but where the top and bottom of the ring is embedded with a very large number of small metal windings, aligned along the beam path such that the circular magnetic field surrounding the beam (naturally generated by the motion of the charged particles), is perpendicular to the major surface of the windings. As the beam circulates in the confinement ring of the reconversion device, ideally under influence of perpendicular magnetic fields and/or path bending electric fields, its own magnetic field interacts with the metal windings in the shell of the ring. As the charged particle beam moves, the magnetic field of the beam, passing through each individual winding, increases and then decreases. This alternating magnetic flux through the windings, causes current to be induced in the windings. The windings are networked in a circuit so as to draw out the current from the device into an external conventional energy storage device such as batteries which act as temporary storage from where power is drawn by an external load. A third method converts the KE of the charged particle beam to electricity by utilizing the principle of conservation of momentum. Here, the charged particle beam is shot at the edge of an oppositely charged spinning wheel. The wheel is designed such that the charged particles attach themselves to the edge of the wheel when the beam is shot at it. When the charged accelerated particles hit the wheel, they cause it to start spinning Since the particles cannot continue along their free path any longer, their linear momentum is converted into the angular momentum of the wheel. Therefore the total linear momentum of the accelerated particle beam is now equal to the total angular momentum of the spinning wheel, and therefore the energy of the wheel is equal to the energy of the beam. As the wheel spins, it drives the shaft of a generator attached to it, thereby generating electric current from the generator. The wheel drives the generator until its energy is exhausted and it comes to a stop. A fourth method uses the emission of electrons from the surface of metals to convert the KE to electricity. The charged particle beam hits metal plates within the reconversion device, and cause electrons to be ejected from the surface of the metal plates. The ejected electrons are drawn out of the device as current and the energy stored in a conventional temporary storage device such as batteries. The device is designed such that the accelerated particles keep hitting metal plates until they lose all their energy, and eject the maximum number of electrons from the surface that their energy level allows. A fifth method uses simple thermal heating to convert the KE to electricity. Here, the charged particle beam is shot into a chamber containing a fluid. The accelerated particles collide with the particles of the fluid, causing it to heat up. Therefore, the kinetic energy of the beam is converted into the thermal energy of the fluid. As the fluid heats up, it expands. A transfer channel allows the superheated fluid to exit the heating chamber and run through a turbine which is connected to a generator. As the superheated fluid runs through the turbine at high pressure, electricity is generated in the generator. After passing through the turbine, the fluid is re-run through the turbine until all or at least most of its usable energy is converted to electricity, and then the fluid is allowed to return to the heating chamber for the next cycle of energy reconversion.

The storage device in one embodiment consists of two rings, an acceleration ring and a storage ring. The acceleration ring receives batches of new particles from the particle source, which are accelerated by running them through the accelerator. At any given time, the accelerator ring only has one batch of particles, all of which are released at the same time by the particle source and have identical characteristics (mass, velocity etc.) and are referred to as ‘bunches’ or ‘beamlets’ herein. The accelerator ring increases the velocity of these particles by repeatedly running them through an accelerator component which uses an acceleration method such as RF cavities or alternating electric fields to impart acceleration to the particles. Once the beamlet (and therefore all particles in it) has attained the maximum allowed velocity, and therefore stored the maximum possible energy, given device specifications, it is shunted across to the storage ring such that it occupies its own small assigned space in the storage ring where it circles the ring continuously. The storage ring can store many batches of particles (beamlets) at any given moment, but each beamlet is separated from every other and the beamlets are shunted in and out such as to ensure there are no collisions between particles. The particles are shunted out of the accelerator ring by applying an electric field across the accelerator ring deflector. The electric field here is applied in a direction perpendicular to the path of the particles such that the particles change their path (move in the direction of the -ve end of the field in case of protons) and gain little or no energy. The deflector works by applying the electric field for a very small period of time when the particles are at the location of the deflector. When no shunting is required, the deflector applies no perpendicular electric field which allows the particles to keep moving in their regular path. When particles have to be removed from the storage ring and moved into the reconversion unit, the same method is applied by the storage ring deflector to move the particles out of their closed loop orbit and into the energy reconversion device. Therefore, in summary, beamlets are generated from the particle source and inserted into the acceleration ring. The acceleration ring accelerates the beamlets to maximum allowed velocity with device specifications. The beamlet is then moved across to the storage ring where it circles the ring continuously, with little or no loss of energy until the time we require energy to be drawn from the device. When energy needs to be drawn from the device, which can be a few seconds or months after energy was stored, the beamlets are moved from the storage ring into the reconversion unit where their kinetic energy is converted back to electricity.

The particles are held in the circular or polygonal ring cavities by the application of a magnetic field along the axis perpendicular to their plane of motion, or using electric field deflectors for bending the beam path. As we know, charged particles move in a circular orbit around the z-axis when the direction of the magnetic field is along the z-axis and initial path of the particles is parallel to the xy-plane. The magnetic field is applied through the use of magnets above and below the rings. This method of confining the particles as well accelerating them is similar to the methods used in particle colliders such as the Tevatron or LHC. However, the invention in present embodiment doesn't require the same methods to be used. Also, while most large scale particle colliders use superconducting magnets to achieve strong magnetic fields, the present invention doesn't require it, as we don't accelerate particles to the same extreme velocities, since our requirement is to maximize energy storage across all particles, rather than energy per particle which is the primary concern of particle colliders.

### BRIEF DESCRIPTION OF THE DRAWINGS

FIG. 1 shows a very simplified view of a charged particle beam. The beam volume 001 is confined within the beam edges 004. The beam consists of many positively charged particles 002 such as protons. However, the beam particles need not necessarily be protons, and can be of various other species.

FIG. 2 shows another charged particle beam, but this one consisting of ions instead of protons. The beam volume 006 is contained within the beam edges 008. The charged particle 010 is an ion carrying a positive charge 012. This beam could possibly allow larger mass density in the beam than the beam in FIG. 1.

FIG. 3 shows a charged particle beam consisting of specially engineered macro-particles, such as carbon chains and fullerenes carrying a net charge. The beam volume 014 is confined within the beam edges 016 and consists of engineered macro-particles 018 each carrying a net charge 020. The beam edges 016 are only a conceptual entity and define the surface within which most, though not necessarily all, of the mass of the beam is confined.

FIG. 4 shows the general overview of the energy storage device, the primary subject of this invention in one embodiment. The device shown consists of two rings 030 and 048 of which one is an accelerator ring 030 and the other the storage ring 048, a power source 022, a particle source 024, an accelerator component 038, three particle deflectors 042, 052 and 058, and energy reconversion unit 064, and temporary conventional energy storage device 066. This view shows a design wherein the accelerator ring 030 and storage ring 048 are permanently connected and form a single device. In other embodiments, the accelerator ring 030 and storage ring 048 can be kept separate as separate devices, and only connected to each other when additional energy needs to be stored in the storage ring 048 by injecting particles (beamlets) into it from the accelerator ring 030.

FIG. 5 shows a separated accelerator ring 030, wherein it is no longer connected to the storage ring. In addition to the configuration from FIG. 4 above, this design includes a ring interconnect dock 070 which allows this ring to be connected to a storage ring securely.

FIG. 6 shows a separated storage ring 048, wherein it is no longer connected to the accelerator ring. In addition to the configuration from FIG. 4 above, this design includes a ring interconnect dock 080 which allows this ring to be connected to an accelerator ring securely.

FIG. 7 shows one embodiment of the accelerator ring from sideways cross-sectional view.

FIG. 8 shows one embodiment of the storage ring from sideways cross-sectional view.

FIG. 9 shows the beam path in a model wherein the beam follows a circular closed loop.

FIG. 10 shows the beam path in a model wherein the beam follows a hexagonal closed loop.

FIG. 11 shows the beam path in a model wherein the beam follows a toroidal closed loop.

FIG. 12 shows the cross-sectional view of one embodiment of a beam ring, which could be an accelerator ring or a storage ring. This view also shows the dipole magnets 142 and 144 which apply the magnetic field which bends the beam.

FIG. 13 shows the cross-sectional view of one embodiment of a beam ring, which could be used in the accelerator ring or storage ring. This view also shows quadrupole magnets 148, 150, 152 and 154 which apply the magnetic field for beam focusing.

FIG. 14 shows the cross-sectional view of one embodiment of a beam ring, which could be used in the accelerator ring or storage ring. This view also shows electric field deflector plates 178 and 176, which apply an electric field across the beam path to bend the beam.

FIG. 15 shows a detailed view of the design from FIG. 14, with details on how the electric field deflector plates 178 and 176 bend the beam 182 from its inertial path.

FIG. 16 shows the cross-sectional view of one embodiment of a beam ring, which could be used in the accelerator ring or storage ring. This view also shows electric field focusing pipe 186, which focuses charged particle beams utilizing similarly charged surfaces to create a cylindrical inwards pointing electric field.

FIG. 17 shows a detailed view of the design from FIG. 16, with details on how the electrically charged pipe 186 focuses the beam 196.

FIG. 18 shows the magnet configuration for a regular accelerator or storage ring, with a combination of dipole magnets 200 for bending and quadrupole magnets 202 for beam focusing.

FIG. 19, shows the component configuration for a hexagonal accelerator or storage ring, with a combination of bending electric field deflectors 210 for bending the beam and quadrupole magnets 212 for beam focusing.

FIG. 20 shows one embodiment of the ionization driven energy reconversion device.

FIG. 21 shows a simplified cross-sectional view of one embodiment of the direct current induction driven energy reconversion device.

FIG. 22 shows a simplified exploded view of one embodiment of the direct current induction driven energy reconversion device.

FIG. 23 shows a simplified theoretical overview of the principle behind the direct current induction driven energy reconversion device.

FIG. 24 shows the details of the metal windings disc of the direct current induction driven energy reconversion device.

FIG. 25 shows a simplified view of the conservation of momentum based energy reconversion device.

FIG. 26 shows a simplified view of the electron ejection based energy reconversion device.

FIG. 27 shows a simplified view of the thermal heating based energy reconversion device.

FIG. 28 shows the general model for energy extraction from the present invention.

FIG. 29 shows a graph of the Lorentz Factor, which is an important physical parameter impacting the size, energy and various other aspects of the design of the present invention.

FIG. 30 shows one embodiment of the beam catchment block, wherein the beam can be destroyed when the equipment is disturbed, to prevent the leakage of the stored energy into the environment.

FIG. 31 shows another embodiment of the beam catchment block, wherein the beam can be destroyed when the equipment is disturbed, to prevent the leakage of the stored energy into the environment.

FIG. 32 shows beamlets as part of the larger beam, to clarify the structure of the beam.

FIG. 33 shows a highly simplified view of an operational grid level system implementing the present invention to store energy on the electrical grid.

FIG. 34 shows the energy flow in the present invention, from the intake of energy from external source to its return to an external load.

FIG. 35 shows the system level design breakdown of one embodiment of the present invention, showing the various components of the system.

### DETAILED DESCRIPTION

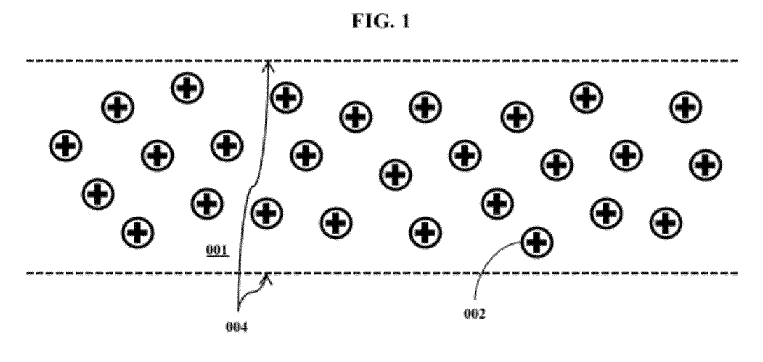

FIG. 1 shows a very simplified view of a charged particle beam. The beam volume 001 is confined within the beam edges 004. The beam consists of many positively charged particles 002 as this is a proton beam. The beam actually used in a given embodiment of the device can vary based on various design considerations. Also, the beam edges 004 only delineate the surface within which most of the mass of the beam is located and are purely conceptual entities. Similarly, the beam particles need not necessarily be protons, and can be of various other particle species, positively or negatively charged with any physically possible net charge. The charged particles 002 in the beam are all of the same charge and therefore repel each other. The more we try to focus the beam, the lesser the space between particles and greater their mutual repulsion. Therefore, a beam consisting of such particles will tend to spread out and disintegrate over time unless an external influence forces the particles back close to each other periodically. This task is accomplished with focusing quadrupole magnets, further described later.

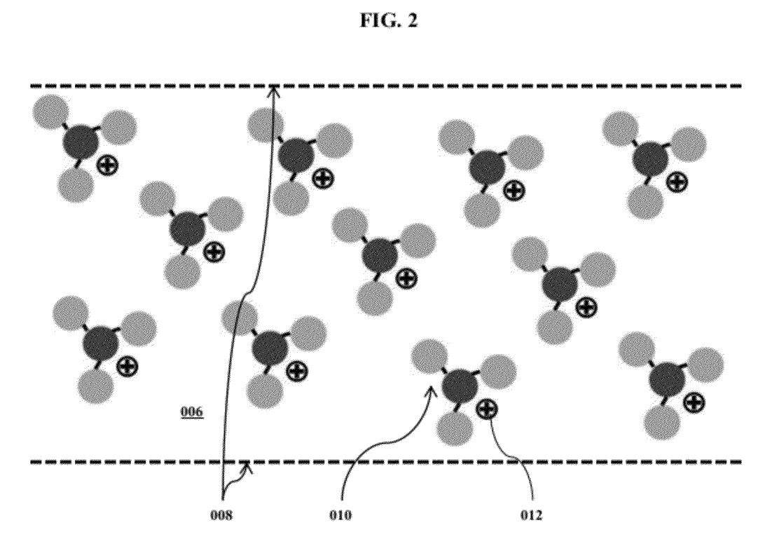

FIG. 2 shows another charged particle beam, but this one consisting of ions instead of protons. The beam volume 006 is contained within the beam edges 008, wherein the beam edges are purely conceptual entities and delineate the surface within which most of the mass of the beam is located. The charged particle 010 is an ion carrying a positive charge 012. Ions 010 within the beam volume 006, will orient themselves within space so as to achieve the lowest energy state, which in this case would involve minimizing the electric field E experienced by each charge, wherein E arises from other charges surrounding the charge on any given ion. Therefore, the ions within the beam volume will orient themselves so as to ‘hide’ their respective charges from other charges in the beam. However, since each particle has multiple sub-particles per unit charge, the charge to mass ratio of this setup allows more mass to be carried in the beam for the same amount of total charge. Also, since each particle by itself consists of many sub-particles, closely packed together, this beam can have much higher mass density compared to beam in FIG. 1.

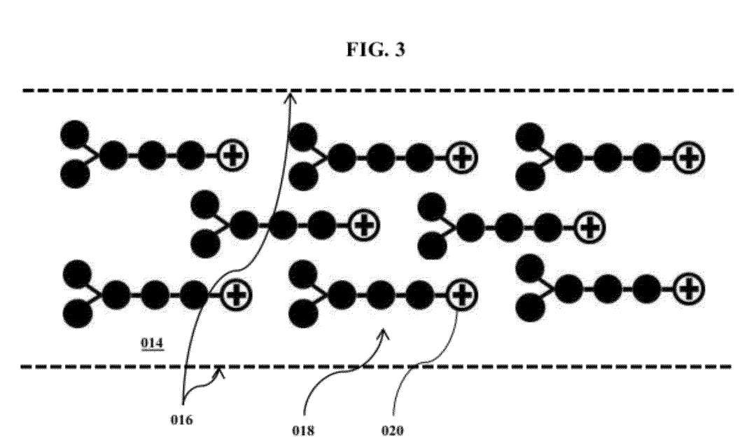

FIG. 3 shows a charged particle beam consisting of specially engineered macro-particles, such as carbon balls or fullerenes carrying a net charge. The beam volume 014 is confined within the beam edges 016 and consists of specially engineered macro-particles 018 each carrying a net charge 020. The beam edges 016 are only a conceptual entity and define the surface within which most, though not necessarily all, of the mass of the beam is confined. Like ions, macro-particles allow much closer packing together of the mass and allow the beam to achieve much higher mass density. Also, like ions, the macro-particle beam particles 018, will orient themselves to achieve the lowest energy state, and shield their respective charges from the ambient electric field generated by surrounding charges. The advantage with macro-particles is that we can engineer them to specifically maximize performance specifications of our device by controlling the mass, shape and charge vectors on the particle.

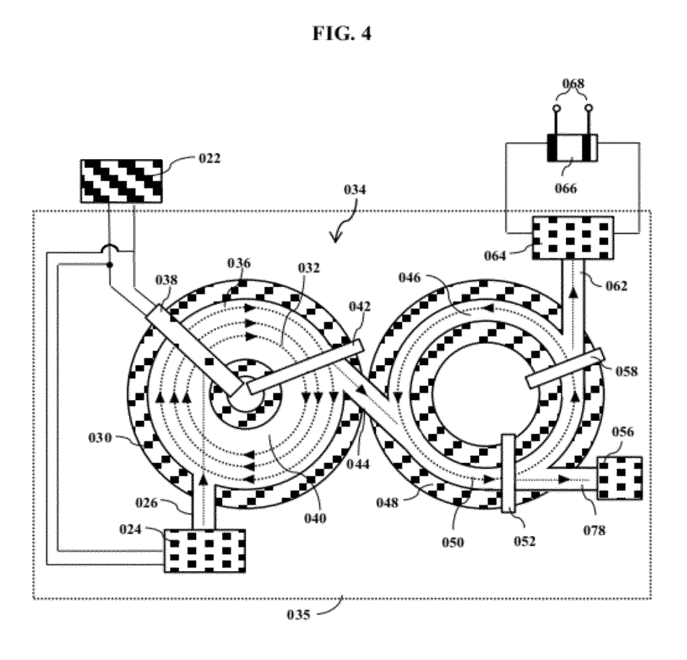

FIG. 4 shows the high-level design of the invention in one embodiment. This design is limited to some of the major components of the system and ignores various necessary components that an actual implementation of the device in physical hardware would require. The design provided here is indicative of only one embodiment of the current invention, and not meant to limit the scope of invention, which can be implemented through various other designs and configurations while still implementing the core concept of energy storage through particle acceleration to near relativistic velocities with specific beam velocity optimized for meeting requirements such as energy density, cost, size and efficiency for commercial applications. The design consists of the following main components: an energy source 022, a temporary conventional energy storage device 066 and the accelerated particle energy storage device 034. The subject of the present invention, the energy storage device 034, shown in one embodiment here, consists of the following components in this embodiment, enclosed within the dotted line 035: a particle source 024, a particle injection channel 026, the accelerator ring 030, the particles accelerator component 038, the particle acceleration cavity 040 in the acceleration ring, the accelerator ring ejection particle deflector 042, the particle transfer channel 044, the accelerated particle storage ring 048, the accelerated particle storage cavity 046 in the storage ring, the energy reconversion unit particle deflector 058, the particle ejection channel 062, the energy reconversion unit 064, the catchment block particle deflector 052, the catchment block exit channel 078 and the catchment block 056.

The device works in the following manner. The objective of the invention is to take energy from the energy source 022, store it in the energy storage device 034 until the time that the energy consuming device connected to 066 through interconnects 068 requires the energy to be delivered to it at a later instant in time. First, the particle source 024 draws energy from the energy source 022 to inject particles through the injection channel 026 into the accelerator ring's (030) particle acceleration cavity 040 which holds a near complete vacuum. The nature of the particles can be varied according to requirements and constraints. For our example, we will assume that the particle is a proton. The particle source injects particles in batches, so the first batch will contain a large number of protons (˜10⁸-10²⁵ protons). The protons enter the acceleration ring with a very small velocity imparted by the particle source unit. The accelerator ring and the storage ring, both have embedded magnets above and below the particle cavities, which generate a transverse magnetic field (along the z-axis when the rings are in the xy-plane). The magnets are not shown in this drawing. In certain embodiments, discussed below, the beam bending magnets can be replaced with electric field deflectors that bend the beam using electric fields instead of magnetic fields. When moving charged particles enter a magnetic field at an angle perpendicular to the direction of magnetic field, they move in circles about the direction of the field. Therefore, if the field is directed towards the z-axis, the charged particles will circle about the z-axis on the xy-plane without loss of energy. This property allows us to make the protons move in circles within the accelerator or storage rings in fixed radii. When the proton enters the acceleration ring 030 in the particle acceleration cavity from the injection channel 026, the magnetic field causes it to trace a circular path over the particle acceleration cavity 040 of the ring. As the proton moves along the cavity, it reaches the accelerator component 038. The accelerator component could use one of many different methods to accelerate the particles such as alternating electric fields or RF cavity. The particle exits the accelerator with a much higher velocity than the velocity with which it entered and traces a new path 032 with a larger radius. The particle (or the batch of particles) then completes a circle around the ring and enters the accelerator component 038 again, where it is again accelerated to a higher velocity. The accelerator ring may have multiple such accelerator components, however the drawing in FIG. 4 defines a design with only one accelerator component. Each time the batch of particles moves through the accelerator, it is accelerated and driven to a higher velocity. The accelerator imparts the acceleration by drawing power from the external energy source 022 and thereby transfers energy from the external source 022 to the particles. As the particles are accelerated to ever higher velocities, their kinetic energy become higher and higher. Therefore, the energy supplied by the external energy source 022, is stored in the form of the kinetic energy of the accelerated particles. The kinetic energy, KE, of the particles is given by the relativistic kinetic energy formula:

$${E}_{k} = m {c}^{2} ( \frac{1}{\sqrt{1 - {( v / c )}^{2}}} - 1 )$$

Where, Eₖ=Kinetic Energy, m=mass, c=speed of light, v=velocity of particle. Therefore, as v increases, Eₖ increases. Thereby the potential energy supplied by 022 is stored as kinetic energy Eₖ of the particles in 030.

However, we cannot increase the velocity of the particles indefinitely, and at some point, we need to continue to increase the energy stored in the device, without increasing the velocity of the particles. For this, we need to create another batch of particles (beamlet) from the particle source 024 and inject them into the accelerator ring 030, for acceleration from their low initial velocity. But before this is done, the previously accelerated beamlet needs to be moved out of the accelerator ring. In order to do this, we move the particles already accelerated to their maximum velocity (within the constraints of the device), currently tracing the path 036, to the storage ring 048 which also has its own accelerated particle cavity 046 where the accelerated particles move in circular paths at fixed velocity and energy in near complete vacuum. The particles are moved into the storage ring by the particle deflector 042, which in this case is a device which applies a perpendicular electric field across the path of the particles, causing them to deviate from their circular path. The deflectors could possibly work in other ways as well, not utilizing electric fields. The deflector only turns on the electric field for an extremely short period of time (generally less than 10⁻³ secs) when the beamlet is within its range. When the field is applied across the particles, they deflect in the direction of the opposite charge of the field (towards the negative end of the field for protons) and move out of their regular orbit within the accelerator ring and enter the storage ring through the particle transfer channel 044. Once in the storage ring 048, the magnetic field of the storage ring dipole path bending magnets keeps the particles circling the circular path of the storage ring cavity 046 for very long periods of time at fixed velocity and energy. The particle cavities 040 and 046 have a vacuum and since the magnetic fields and e-fields are perpendicular to the direction of motion of the particles, there is no loss of energy while the particles are moving in circles except for losses caused by effects such as synchrotron radiation and space charge. The device can hold the stored energy in the form of kinetic energy of the particles for very long periods of time (thousands of hours) without significant energy loss. However, energy losses will occur over time for various reasons, as the beam degenerates.

Over time, as another beamlet of particles is accelerated to peak velocity in the acceleration ring, it is also shunted across to the storage ring where it joins the existing beamlets in the storage ring particle beam 050. However, the transfer timing is managed such that each beamlet is separate from every other beamlet and there is no collision of particles within the device. These beamlets of particles in accelerator physics are generally referred to as ‘bunches’. This process is continued till the maximum number of particle beamlets, as limited by the device design, that can be accommodated within the storage ring is reached.

Eventually, we will need to extract the stored energy to perform some work. At such time, the particles will need to be ejected from the storage ring and their kinetic energy converted back to potential energy (electricity) which can do work. This is accomplished in the present embodiment as described below.

When energy needs to be extracted from the storage ring 048, a beamlet of particles is deflected out of the storage ring 048 and into the particle ejection channel 062 by the ejection deflector 058. The particles travel across the ejection channel and enter the energy reconversion unit 064 where the KE of the particles is reconverted to electricity. The energy reconversion device 064 can be implemented with various different methods, some of which are discussed below. The electricity generated from the energy reconversion device 064 is used to charge up a temporary conventional storage device 066. 066 can be a conventional device such as a battery and holds only a very small fraction of energy stored in 034 at any given time and is used to make electricity available to an external load through interconnects 068 in an easily usable form with voltage, power and quality as required by the load.

In order to make the device safe for commercial use it is important that the energy contained in the device is not released into the environment in a dangerous manner. Primarily, we need to protect the device from external shocks that might result in an explosive release of the energy into the environment which can cause damage to surroundings. To prevent this, the device is outfitted with various sensors and controllers which help detect any danger signals such as powerful impacts or strong vibrations which may threaten the structural integrity of the device. When a danger signal is detected, the system controllers activate catchment block deflector 052, which deflects the beam out of the storage ring into the catchment block channel 078. The beam travels through the catchment block channel 078 and is absorbed inside the catchment block 056. The internal details of the catchment block 056 are given further below.

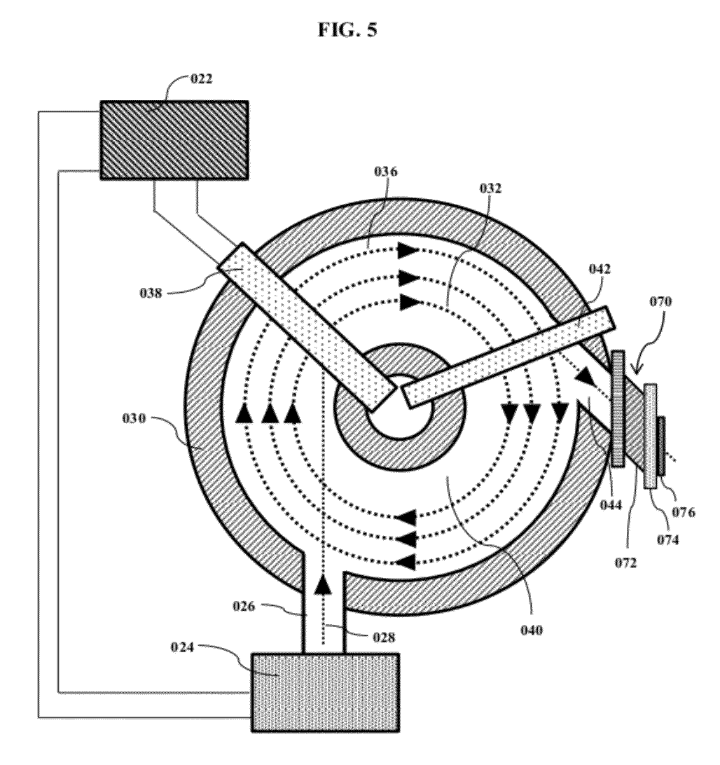

FIG. 5 shows a separated accelerator ring 030, wherein it is no longer connected to the storage ring. In addition to the configuration from FIG. 4 above, this design includes a ring interconnect dock 070 which allows this ring to be connected to a storage ring securely. The interconnect dock 070 consists of a beam transfer channel 072, a channel head 074 which locks into the storage ring dock and a vacuum sealing cap 076 which provides a vacuum lock to the device and is opened only when the ring is connected to a storage ring and complete vacuum is established on both ends.

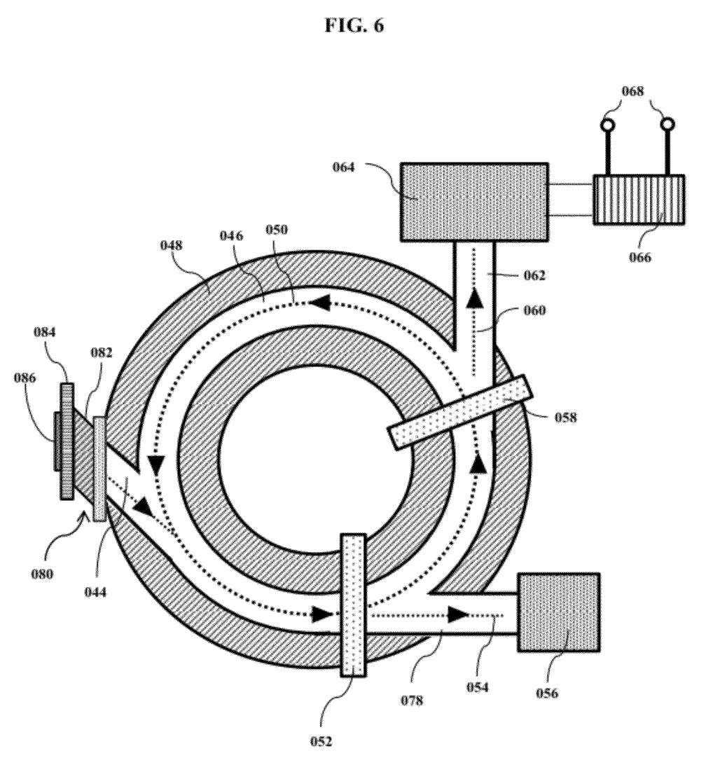

FIG. 6 shows a separated storage ring 048, wherein it is no longer connected to the accelerator ring. In addition to the configuration from FIG. 4 above, this design includes a ring interconnect dock 080 which allows this ring to be connected to an accelerator ring securely. The interconnect dock 080 consists of a beam transfer channel 082, a channel head 084 which locks into the accelerator ring dock and a vacuum sealing cap 086 which provides a vacuum lock to the device and is opened only when the ring is connected to an accelerator ring and complete vacuum is established on both ends. Paired with a separated accelerator ring, the independent storage ring can prove useful in many use cases such as motor vehicles, ships, submarines, aircrafts and more. This design illustrates the fact that the storage ring and the accelerator ring of the present invention are separable and need not be connected to each other at all times. In certain embodiments, we might have a single accelerator ring for many storage rings, as particles are accelerated and injected into each storage ring sequentially from the single accelerator ring. This separation allows reduction of overall system and deployment cost and also reduces the device size for applications such as motor vehicles, where only the storage ring may be placed on the vehicle while the accelerator ring is located at refueling stations where drivers can take their vehicles to periodically recharge their storage rings with new batches of accelerated particles.

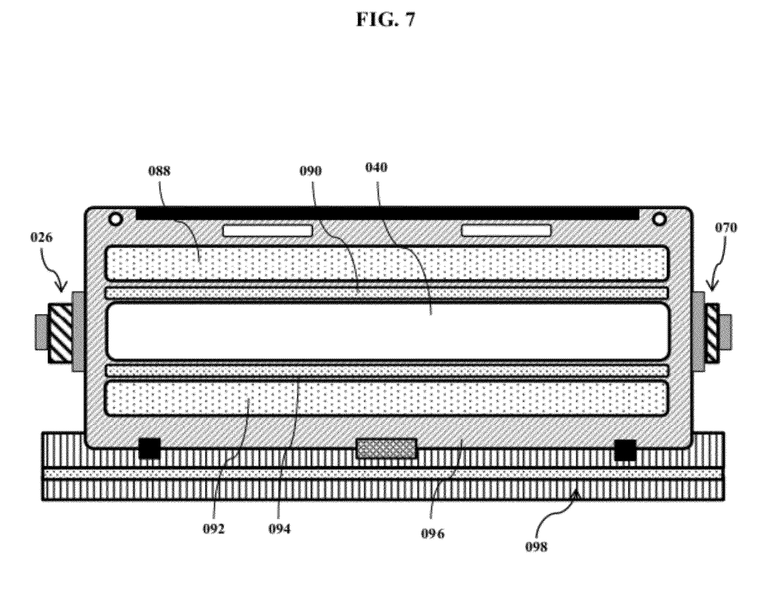

FIG. 7 shows one embodiment of the accelerator ring from sideways cross-sectional view. It consists of the injection channel 026, the beam transfer channel 070, top bending dipole magnet 088, and bottom bending dipole magnet 092, the top sensor and components chamber 090, the bottom sensor and components chamber 094, the acceleration ring vacuum cavity 040, the device shell 096 and device foundation 098 which holds it stably to the ground. This is a very simplified view of one embodiment wherein we have a single set of dipole magnets and a single cyclotron like vacuum cavity for acceleration. A true implementation is likely to be considerably more complex. Here, the particle beam enters from 026, is accelerated in 040, within the dipole magnetic field of 088 and 092 which hold the beam in a circular path. The sensors and controllers in 090 and 094 help control the acceleration, beam shape and beam trajectory among other things. Once fully accelerated, the beam is shifted to the storage ring via transfer channel 070.

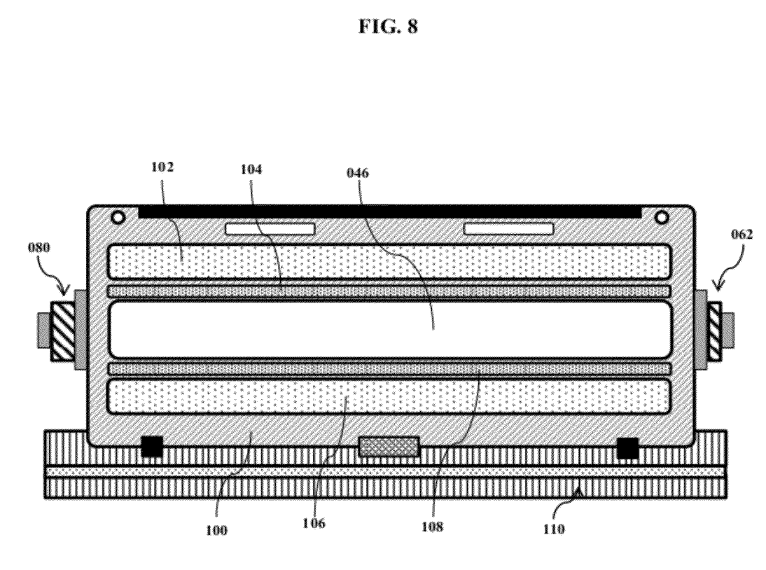

FIG. 8 shows one embodiment of the storage ring from sideways cross-sectional view. It consists of the beam transfer channel 080, the beam ejection channel 062, top bending dipole magnet 102, and bottom bending dipole magnet 106, the top sensor and components chamber 104, the bottom sensor and components chamber 108, the storage ring vacuum cavity 046, the device shell 100 and device foundation 110 which holds it stably to the ground. This is a very simplified view of one embodiment wherein we have a single set of dipole magnets. A true implementation is likely to be considerably more complex.

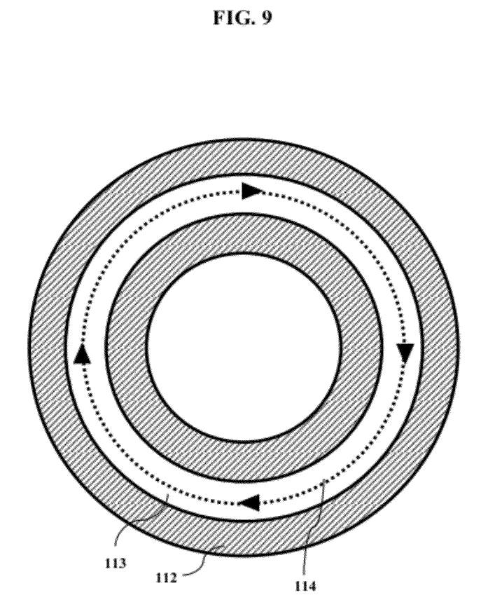

FIG. 9 shows the beam path in a model wherein the beam follows a circular closed loop. This is a depiction of the simplest charged particle beam path wherein the particle beam (or beamlet) maintains a constant velocity and is bent by the presence of a perpendicular magnetic field of uniform intensity across its entire path. The ring 112 holds a vacuum channel 113 within which the beam 114 circles continuously.

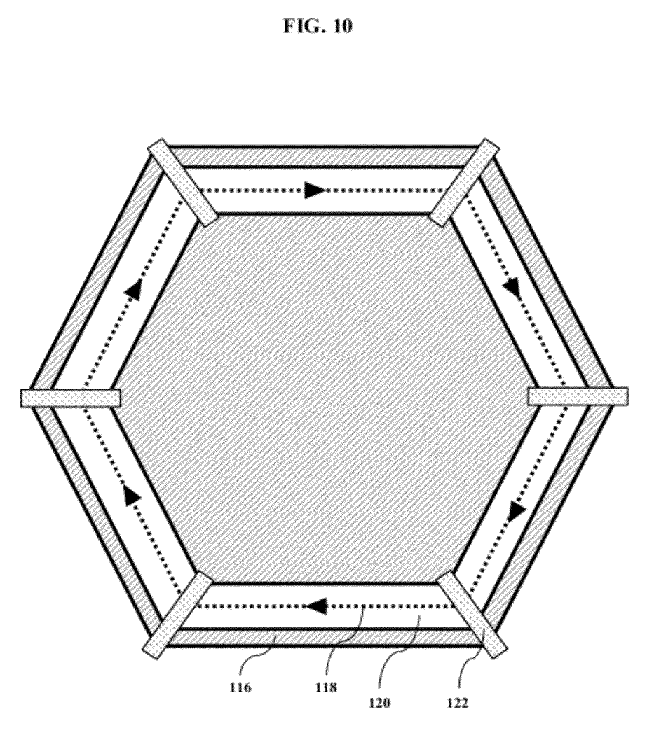

FIG. 10 shows the beam path in a model wherein the beam follows a hexagonal closed loop. The beam ring 116 contains a vacuum channel 120 within which the beam 118 traces a hexagonal closed loop path. This model does not utilize magnets to bend the beam into a closed loop path. Instead we utilize a series of electric field deflectors 122 to bend the beam at the corners of the hexagon. The electric field deflectors apply an electric field perpendicular to the path of the beam, along or opposite the direction in which we want to bend the beam (depending on beam charge type). When the beam hits the electric field, it changes direction. A positively charged beam will move towards the negative end of the field, while a negatively charged beam will move to the positive end of the applied field. The deflectors 122 will do some work on the charge, but ideally in extremely small amounts, so the beam energy doesn't change in any significant way. The electric field deflectors offer some advantages over magnets for bending the beam. For one, they allow the perimeter of the device to be made much smaller by allowing much stronger bending of the beam than is possible with common permanent magnets. This allows us to considerably increase the energy density of the device by reducing device size. Second, it allows us to reduce or eliminate the need for magnets, which can be very expensive at times.

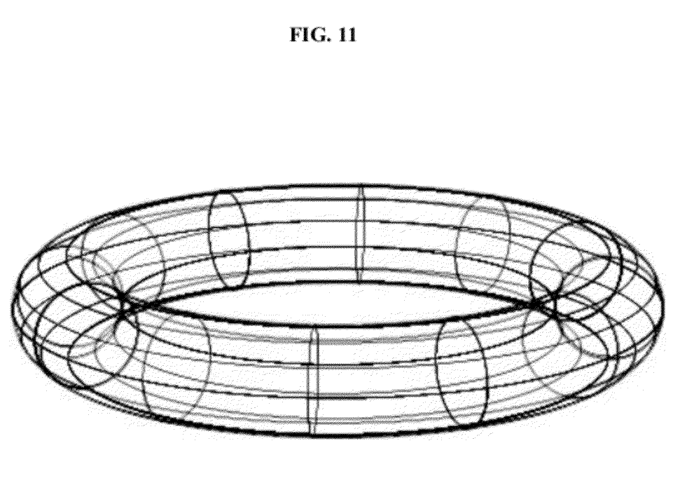

FIG. 11 shows the beam path in a model wherein the beam follows a toroidal closed loop. This design is similar to Tokamaks and requires complex electric and magnetic fields to be achieved. Similarly, we can also have a toroidal coil path, wherein the beam executes a coiled path around the surface of a toroid. This would allow a much larger path within a small space and may be useful in some design configurations.

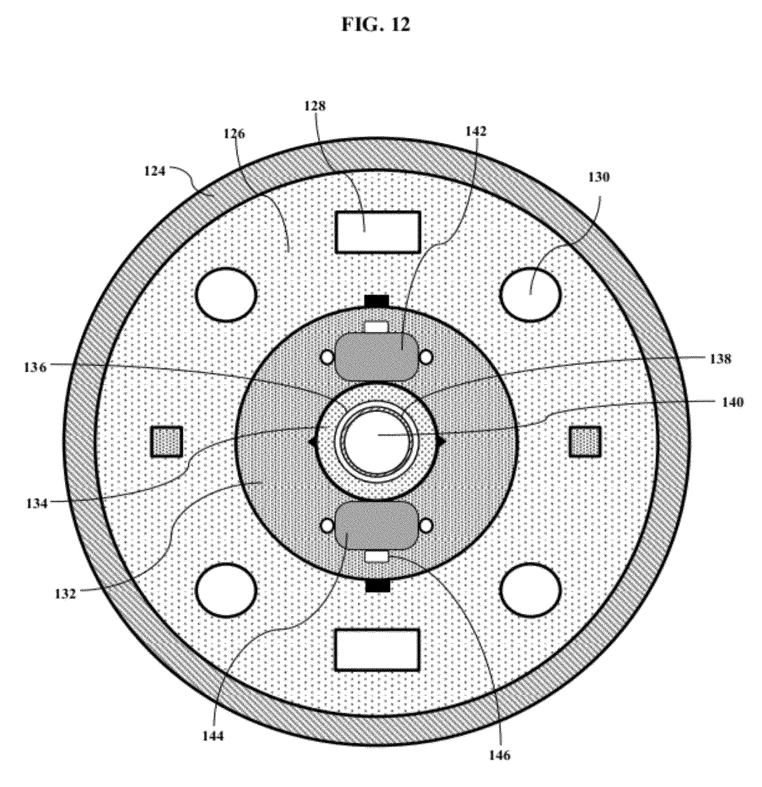

FIG. 12 shows the cross-sectional view of one embodiment of a beam path ring, which could be an accelerator ring or a storage ring. This view if cut from the plane perpendicular to the length of the beam path ring and therefore perpendicular to the direction of the beam in the ring. The beam in the storage or accelerator ring will in a real device not be carried in a cavity as suggested above but in a beam ring similar to one shown in FIG. 12. The beam ring consists of the beam ring shell 124, the external yoke 126, the internal yoke 132, the controller and sensor channel 128, wiring channel 130, dipole magnets 142 and 144, the beam pipe shield 134, the beam pipe 136, the beam pipe internal coating 138 and finally the beam pipe vacuum channel 140 where the beam itself travels. The shell 124 provides external protection to the system. The external yoke 126 holds the contents in place. The internal yoke 132 holds additional contents in place. The controller and sensor channel 128 carries various controllers and sensors that help control the operation of the ring and the transport of the beam. The wiring channel 130 carries wires. The dipole magnets 142 and 144 generate the transverse magnetic field which bends the charged particle beam path. The beam pipe shield 134 protects the beam, while the beam pipe 136 itself carries the beam within itself. The beam pipe may also have internal coating 138 to prevent desorption and maintain a complete vacuum by absorbing free particles. Magnet locking holes 146 help lock the magnets in place.

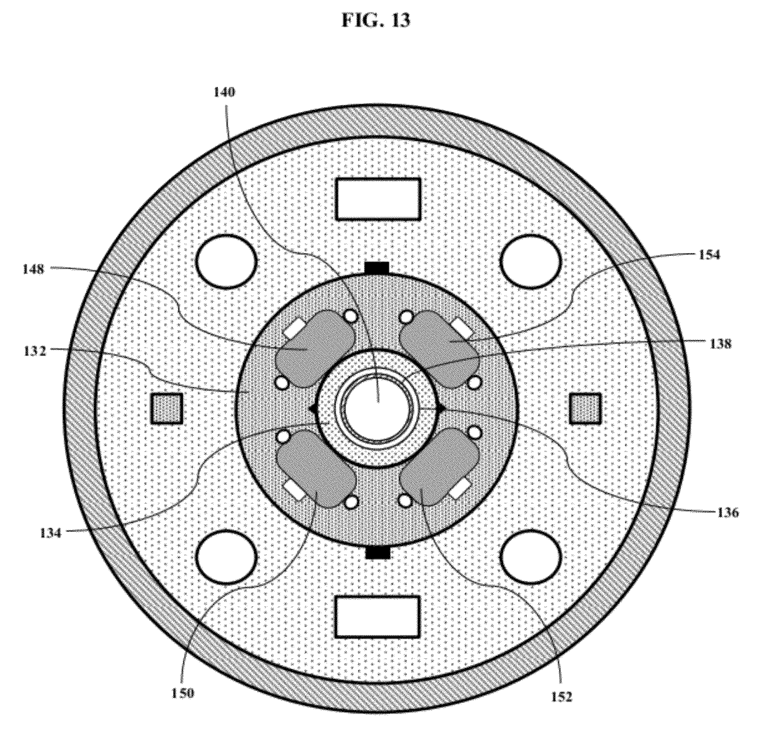

FIG. 13 shows the cross-sectional view of one embodiment of a beam ring, which could be used in the accelerator ring or storage ring. This view also shows quadrupole magnets 148, 150, 152 and 154 which apply the magnetic field for beam focusing. Components 132, 134, 136, 138 and 140 are the same as in FIG. 12. However, instead of dipole magnets which are used for bending the beam, here we have quadrupole magnets which focus the beam to drive all beam particles closer together and prevent the beam from spreading out decaying. The quadrupole magnets 148, 150, 152 and 154 are place at corners of a quadrilateral and create a magnetic field such that all stray particles in the beam are pushed back into the beam.

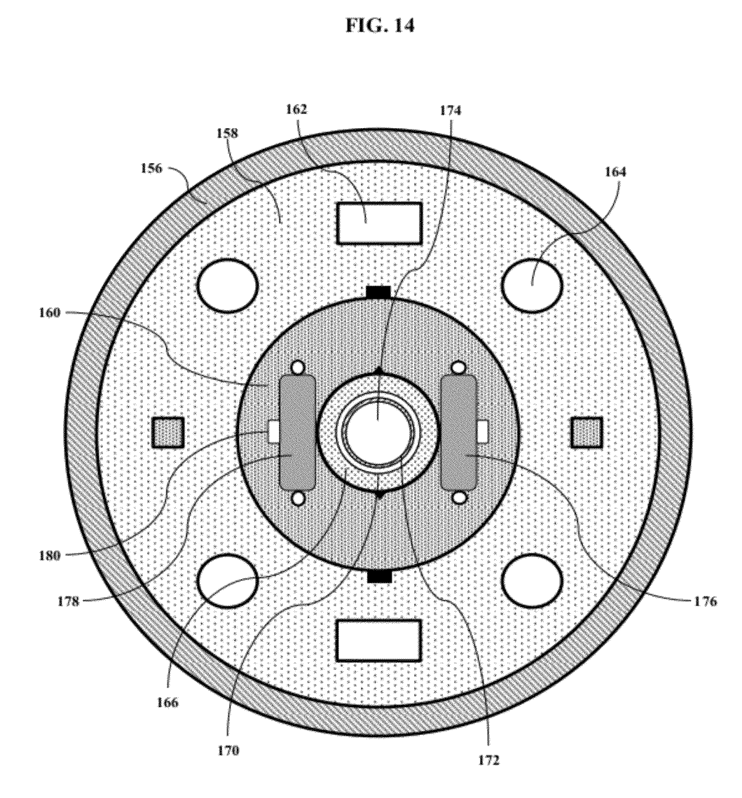

FIG. 14 shows the cross-sectional view of one embodiment of a beam ring utilizing electric field deflectors in place of dipole magnets to bend the beam, which could be used in the accelerator ring or storage ring. This view also shows electric field deflector plates 178 and 176, which apply an electric field across the beam path to bend the beam. The beam ring consists of the beam ring shell 156, the external yoke 158, the internal yoke 160, the controller and sensor channel 162, wiring channel 164, electric field deflectors 178 and 176, the beam pipe shield 166, the beam pipe 170, the beam pipe internal coating 172 and finally the beam pipe vacuum channel 174 where the beam itself travels. The shell 156 provides external protection to the system. The external yoke 158 holds the contents in place. The internal yoke 160 holds additional contents in place. The controller and sensor cavity 162 carries various controllers and sensors that help control the operation of the ring and the transport of the beam. The wiring cavity 164 carries wires. The electric field deflector plates 176 and 178 generate a perpendicular electric field across the face of the ring which bends the charged particle beam path. The beam pipe shield 166 protects the beam, while the beam pipe 170 itself carries the beam within itself. The beam pipe may also have internal coating 172 to prevent desorption and maintain a complete vacuum by absorbing free particles. Locking holes 180 help lock the electric field deflector plates in place.

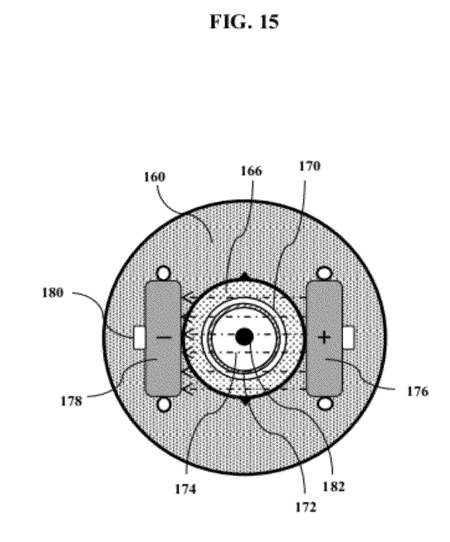

FIG. 15 shows a detailed view of the design from FIG. 14, with details on how the electric field deflector plates 178 and 176 bend the beam 182 from its inertial path components 160, 166, 170, 172, 174, 178, 176 and 180 are same as defined above. In this design, the plate 176 is positively charged while plate 178 is negatively charged creating an electric field from 176 to 178. When the beam 182 hits the field, if it carries a positive charge, it will bend towards 178. The angle of the bend will be determined by the strength of the magnetic field for a given beam. For a fixed field, the angle of bend will be determined by the mass and velocity of the beam.

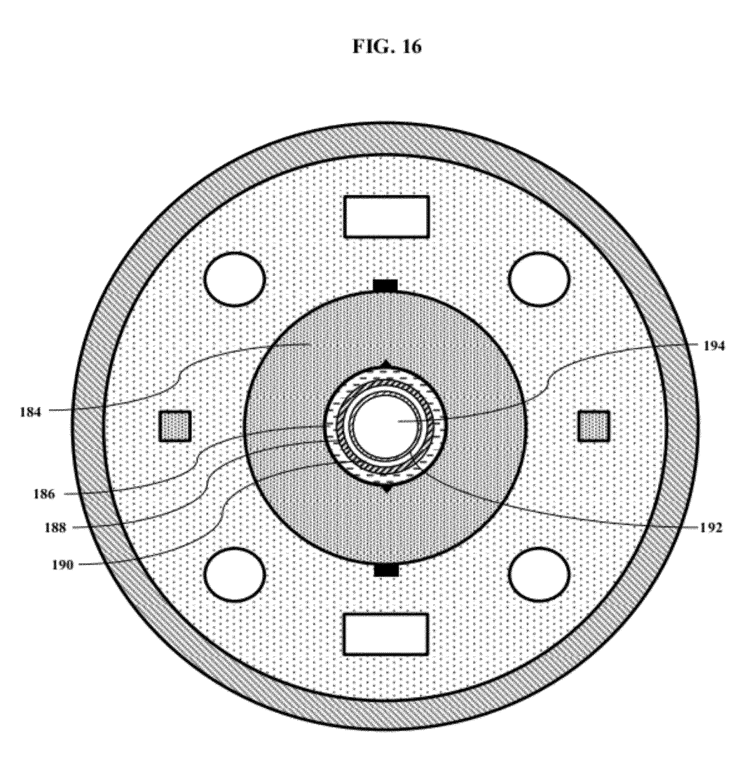

FIG. 16 shows the cross-sectional view of one embodiment of a beam ring, which could be used in the accelerator ring or storage ring for beam focusing using electric fields. This view also shows electric field focusing pipe 186, which focuses charged particle beams utilizing similarly charged surfaces to create a cylindrical inwards pointing electric field. 184 is the inner yoke of the ring which holds contents in place, 186 is the charged beam focusing pipe which carries a uniform charge and thereby creates an electric field emanating inwards and outwards from its cylindrical surface. While the outwards field is absorbed by the yoke, the internal field travels through the beam pipe and creates a uniform cylindrical field with minimum strength at the center line of the beam pipe and increasing intensity closer to the walls of the beam pipe. 188 is the charged beam focusing pipe insulator while 190 is the beam ring and 192 the internal coating of the beam ring. 194 is vacuum channel where the beam travels and where the electric field created by the charged focusing pipe expresses itself

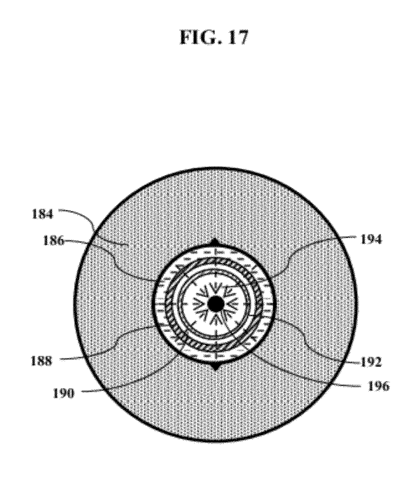

FIG. 17 shows a detailed view of the design from FIG. 16, with details on how the electrically charged pipe 186 focuses the beam 196. The components 184, 186, 188, 190, 192 and 194 are the same as defined above. The particle beam 196 experiences an inward focused electric field from all directions, with field lines perpendicular to the walls of the beam pipe. The intensity of this field is minimum at the centre and it increases towards the walls of the beam pipe uniformly in all directions. The field forces all beam particles to the lowest energy state, which is at the center. Whenever particles stray out of the beam and move towards the walls, the electric field pushes the particles back to the center of the beam pipe thereby strongly focusing it.

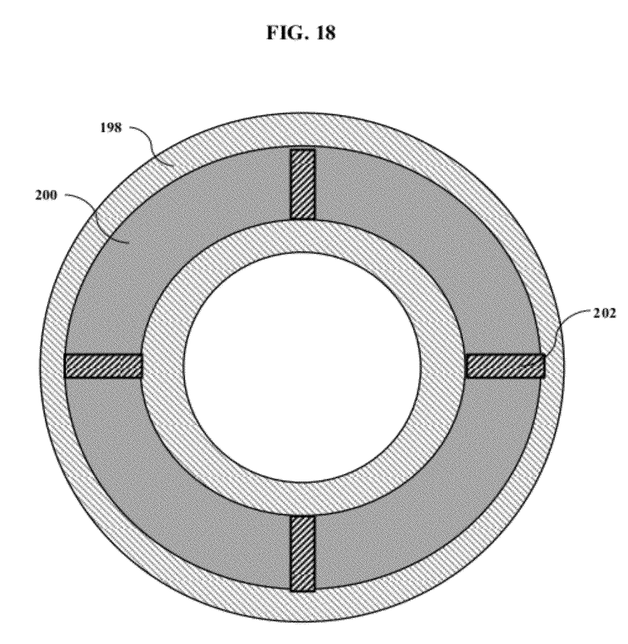

FIG. 18 shows the magnet configuration for a regular accelerator or storage ring 198, with a combination of dipole magnets 200 for bending and quadrupole magnets 202 for beam focusing. This is the standard beam ring configuration where most of the beam path is embedded with dipole magnets to bend the beam, with quadrupole magnets at periodic intervals to focus the beam. Our device in some embodiments could utilize this ring design.

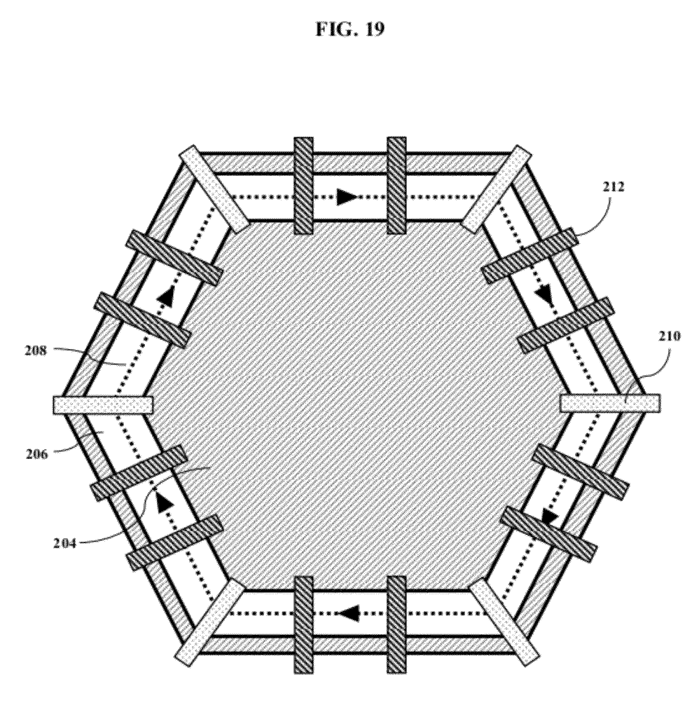

FIG. 19, shows the component configuration for a hexagonal accelerator or storage ring 204, with a combination of bending electric field deflectors 210 for bending the beam path and quadrupole magnets 212 for beam focusing. The beam 208 travels in the vacuum channel 206. In this configuration, we bend the beam using electric field deflectors 210, not dipole magnets, but still use quadrupole magnets 212 for focusing the beam. Unlike dipole magnets, we only need the deflectors at corners of the ring where we bend the path, not all along the beam path. The storage and accelerator rings in our device could utilize this configuration as well in some embodiments.

Similar to configurations in FIG. 17 and FIG. 18, we can have a beam ring configuration where we utilize electric field deflectors for bending the beam path and charged pipe beam focusing from FIG. 16, to focus the beam. In this model, no magnets will be required for bending or focusing the beam. The storage and accelerator rings in our device could utilize this configuration as well in some embodiments.

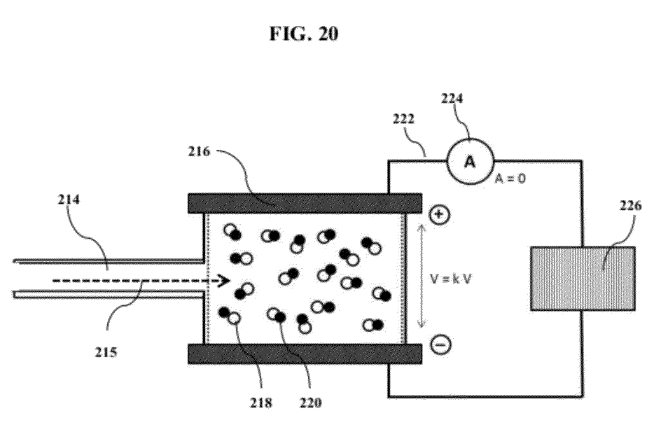

FIG. 20 shows one embodiment of the ionization driven energy reconversion device. The device consists of an injection channel 214, the ionization chamber 216, and positive and negative sub-particles 218 and 220 within the ionization chamber. For explanation, a set of external wires 222, and external load 226 and an ammeter 224 are also shown, though they do not constitute the design of the core device. Particle beam (beamlet) 215 is injected into the ionization chamber via 214. The accelerated particles in the beamlet 215 strike the neutral particles within the fluid of the ionization chamber 216. When the accelerated particles strike the neutral fluid particles, they cause it to ionize breaking into positive and negative sub-particles 218 and 220. A small electric field applied across the chamber causes the positive and negative ions 218 and 220 to move towards opposite ends of the chamber thereby creating and electric field within the chamber. The opposite ends of the chamber are made of metal and connected via external wires 222 to a load 226. When the load 226 is switched on, current travels through the wires 222 and drives the load 226. The generation of the current is displayed by the ammeter 224. As the current is drawn, the electro-motive force within the chamber, created by the separation of oppositely charged ions reduces, and the ions recombine to become neutral again.

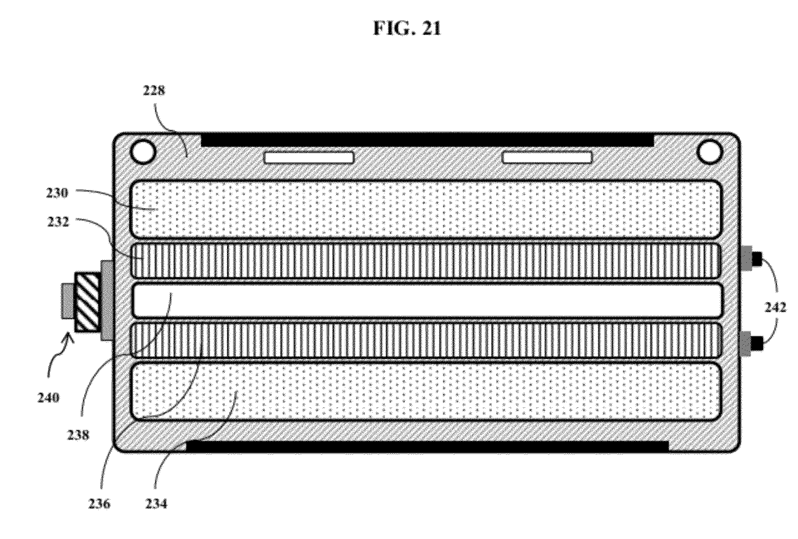

FIG. 21 shows the simplified cross-sectional view of one embodiment of the direct current induction driven energy reconversion device. The body of the device 228 includes a top magnet 230, a bottom magnet 234, the top induction disc 232, the bottom induction disc 236, the particle injection channel 240, and the beam circulation cavity 238. Current generated from the induction discs 232 and 236 is drawn out of the device from interconnects 242. The principle of operation of the device is as follows. The charged particle beam is injected into the beam circulation cavity 238 through the injection channel 240. When the beam enters the circulation cavity, it experiences a transverse magnetic field from the top and bottom dipole magnets 230 and 234. Under the influence of this field, the beam circulates in circles continuously within the vacuum circulation cavity 238. The induction discs 232 and 236, have embedded within themselves small metal windings, networked together in a parallel circuit, all over the entire volume of the discs. Like metal windings in a generator, when these windings experience a time varying electric field they generate current, following Faraday's law. As the injected beam travels in circular paths within the vacuum cavity, it also carries a self-generated magnetic field with it as all charges in motion always do. The magnetic field of the charged particles beam passes through the metal windings in the induction discs. As the beam moves in and out of the vicinity of each winding, the magnetic flux through the windings increases and then decreases. This time varying magnetic flux through the windings due to the motion of the charged particle beam induces a current in the metal windings which is drawn out through the circuit to which each winding is connected. Therefore, the energy of the charged particle beam is converted to electricity by the inductions discs. As the charged particle beam moves and loses energy to the induction disc current, its energy reduces and therefore its radius of motion decreases. The beam therefore traces a spiral path in the direct induction energy reconversion device.

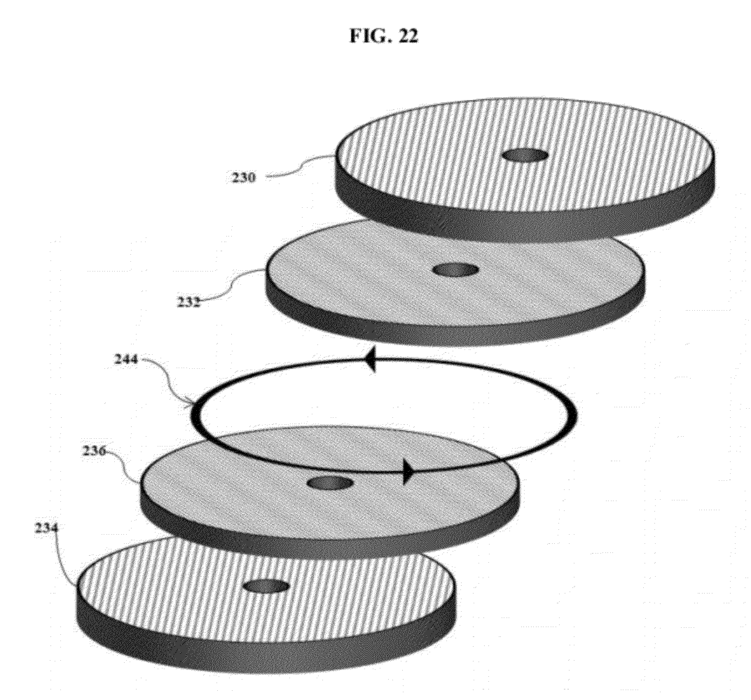

FIG. 22 shows a simplified exploded view of one embodiment of the direct current induction driven energy reconversion device. We can see the top magnet 230, the bottom magnet 234, the top induction disc 232 and the bottom induction disc 236. We can also see the charged particle beam 244 circulating in between the induction discs.

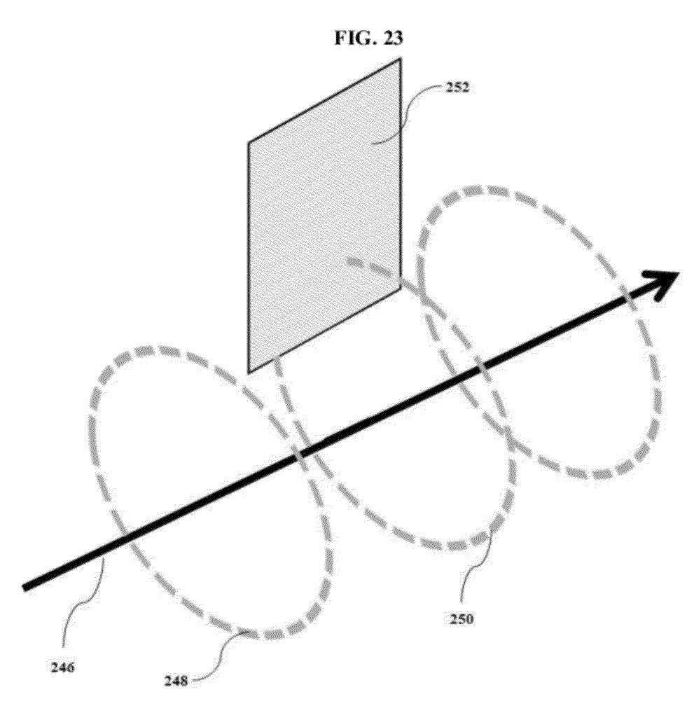

FIG. 23 shows a simplified theoretical overview of the principle behind the direct current induction driven energy reconversion device. The charged particle beam 246 generates a circular magnetic field 248 along the plane perpendicular to its direction of motion. The metal windings in the induction disc are arrayed all along the path of the charged particle beam. As the beam moves near one winding 252, its magnetic field enters the metal winding 252 perpendicular to the face of the winding. This increases the magnetic flux in the winding. As the beam continues to move, the magnetic field exits the winding 252, which in turn reduces the magnetic flux in the winding 252. Therefore, the metal winding 252 experiences a time varying magnetic flux through itself, which causes current to be generated in the winding. As the beam 246 exits one winding, it enters the next winding, which in turn experiences its own time varying magnetic field, causing it to produce current as well. 250 in the figure shows a magnetic field line intersecting with the metal winding 252.

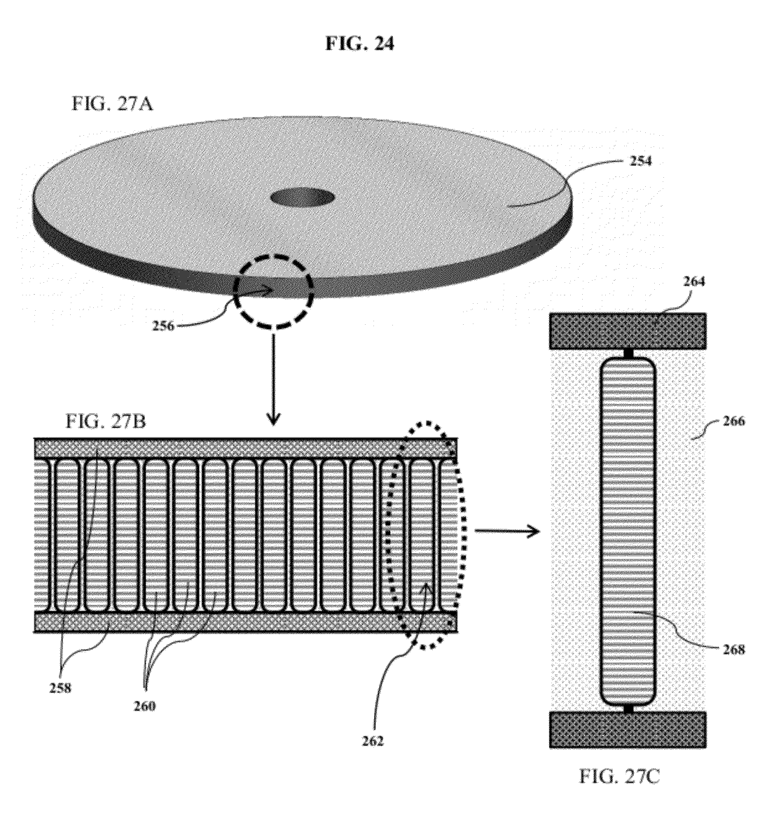

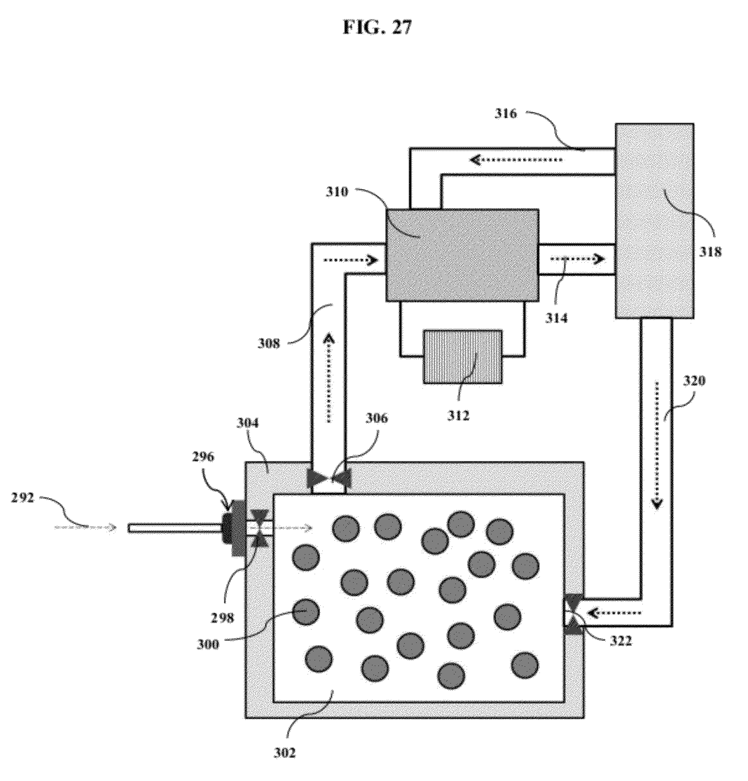

FIG. 24 shows the details of the metal windings disc of the direct current induction driven energy reconversion device. FIG. 27A shows a direct induction disc 254. The metal windings are embedded within the volume of the disc arrayed all along the possible paths a charged particle beam would take. We can see a side view of the disc in 256, which is magnified in FIG. 27B. As we see in FIG. 27B, the direct induction disc consists of top and bottom plates 258 within which the metal windings are embedded. Metal windings 260 embedded within the disc. In 262 we can see a section of the disc which is magnified in FIG. 27C. in FIG. 27C we can see the disc plates 264, the metal winding 268 with wires wound around it, and insulating filler material 266 which fills the space between the individual windings.

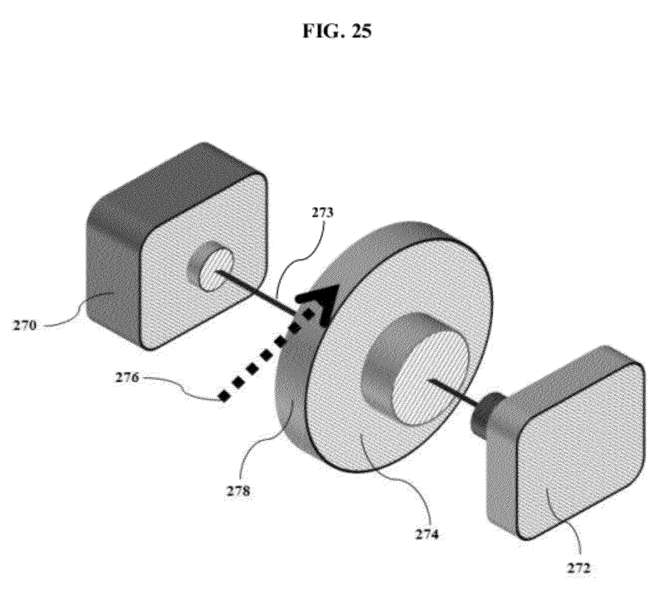

FIG. 25 shows a simplified view of the conservation of momentum based energy reconversion device. The device consists of a generator 270, a spinning wheel 274, a shaft 273 connecting the spinning wheel to the generator and a wheel stabilizer 272. The principle of operation of this device is as follows. A charged particle beam 276 is shot at the surface 278 of the edge of the spinning wheel 274. The spinning wheel edge surface 278 is charged opposite to the charge of the beam particles. Also, it is designed so as to prevent ricocheting of the beam particles and to capture them at the surface when they hit the surface. The beam particles strike the surface 278 tangentially, and are captured by the surface. Since the beam particles carry tremendous linear momentum owing to their enormous velocities, that momentum converts into the angular momentum of the spinning wheel 274. So the spinning wheel starts spinning and drives the shaft 273 which drives the generator 270 to produce electricity. The wheel stabilizer 272 helps hold the spinning wheel 274 in position and stabilize its spinning The speed of spinning of the wheel 274 is much less than speed of the beam particles. This is because according to conservation of momentum, the speed of the wheel is equal to the momentum of the particle beam divided by the inertia of the wheel, where inertia is proportional to the mass and radius of the wheel. Therefore, as we increases the mass and radius of the wheel, its velocity will become lower and lower. All of the energy of the particle beam will be converted to the energy of the spinning wheel, while the rate at which it is drawn out of the wheel will depend on spinning speed of the wheel (its angular velocity). A smaller lighter wheel will spin fast and for a short time and convert all the beam energy to electricity quickly, while a large heavy wheel, will spin slower but longer, and convert all the beam energy to electricity over a longer time.

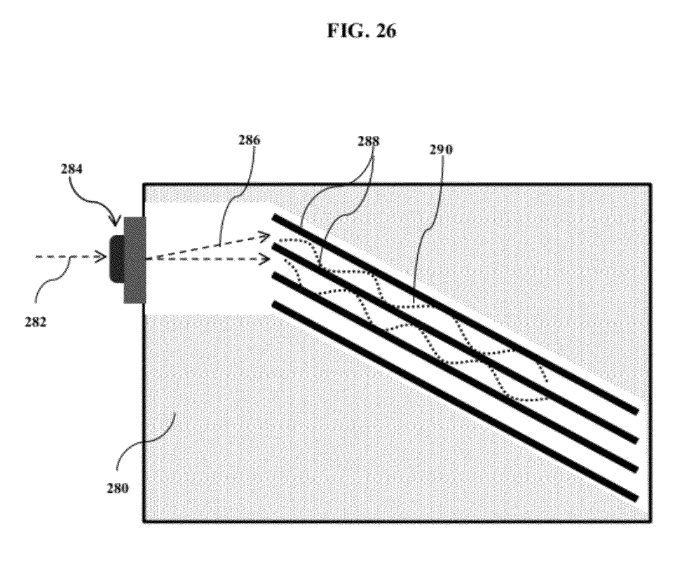

FIG. 26 shows a simplified view of the electron ejection based energy reconversion device. The device body 280 contains electron ejection metal plates 288. These plates have high propensity to eject electrons when hit by a particle. The particle beam 282 enters the device through the injection channel 284. The beam within the device 286 is directed in specific angles and strikes the metal plates 288 which are placed at an angular position with respect to the beam path with small gaps between them. When the beam hits a plate, it causes electrons to be freed from the plate surface, which electrons are then drawn out by an external circuit as current. The beam particles after striking a plate, ricochet off its surface and strike the plate on the other end, causing more electrons to be freed from the surface, generating more current. The beam particles therefore follow a cyclical up and down path 290 as they strike the plates on either end repeatedly. In this manner the kinetic energy of the electron is converted to electricity in the device. As the beam particles repeatedly strike the plates, they lose energy and eventually almost all their kinetic energy is converted to electricity.

FIG. 27 shows a simplified view of the thermal heating based energy reconversion device. The device consists of a thermal heating chamber 304, a beam injection channel 296, injection valves 298, thermal heating chamber internal cavity 302, thermal fluid particles 300, hot fluid valve 306, hot fluid channel 308, mini-turbine 310, a generator 312, used fluid channel 314, recirculation unit 318, used fluid return channel 316, cold fluid channel 320 and cold fluid valve 322, a particle beam 292 enters the thermal heating chamber 304 via the injection channel 296. The injection valves 298 open when beam is about to enter. The device is designed such that the injection channel is larger than the beam particles cross-sectionally allowing the beam particles unrestricted entry, however is smaller than the thermal fluid particles, so tey cannot exit the thermal chamber through the injection channel. On entry, the beam strikes the thermal fluid particles 300 within the thermal chamber internal cavity 302. On striking the particles, the beam heats up the fluid. The beam continues striking the thermal fluid particles 300 until all of its kinetic energy si converted to heat energy of the thermal fluid. The heating caused by the beam causes the thermal fluid to expand considerably. The fluid therefore opens up the hot fluid valves 306 and enters the mini-turbine 310. The high pressure fluid drives the turbine 310 which in turn drives the generator 312 to generate electricity. The hot fluid cools down a little and exits the turbine through used fluid channel 314. It then enters the recirculation unit 318 where the still hot fluid is returned to the turbine for further circulation via used fluid return channel 316, while cold fluid is returned to the thermal chamber 304 via the cold fluid channel 320. The cold fluid re-enters the thermal chamber 304 when the cold fluid valve 322 opens to allow entry.

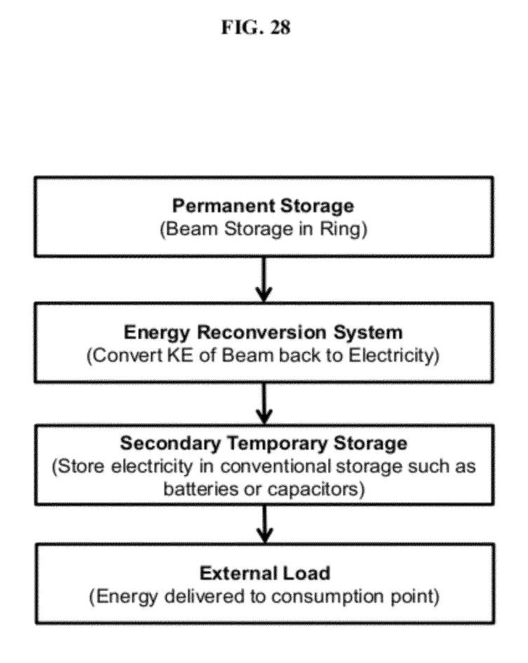

FIG. 28 shows the general model for energy extraction from the present invention. Energy once stored in the accelerated particle energy storage device needs to be extracted in stages in the current model. The storage ring forms the permanent storage of the device, where very large amounts of energy can be stored within a very small volume and mass, for significant lengths of time. However, the storage ring in this model is not well suited for supplying energy directly to an energy consuming load. In order to make the energy stored in the accelerated particle energy storage ring available for use by standard load, we first convert the KE of the particles in the storage ring to electricity in the energy reconversion unit, which can be implemented in many different ways including the methods proposed above. The reconversion unit generates electricity, which is then stored in a conventional device such as batteries for a short period as it is drawn out by the external load. At any point of time, the temporary storage will hold a small fraction of the energy held in the permanent storage. The maximum energy in the temporary storage will be equal to or less than the KE of the beamlet extracted. While the energy of the permanent storage is many thousand times more depending on number of beamlets in the storage ring beam.

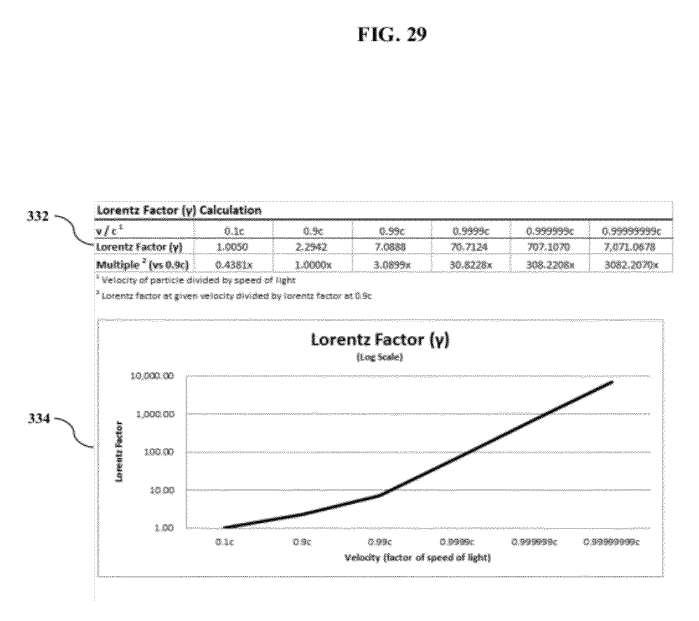

FIG. 29 shows a graph of the Lorentz Factor, which is an important physical parameter impacting the size, energy and various other aspects of the design of the present invention. As we can see, the Lorentz factor grows exponentially as the velocity of the particle approaches the speed of light. Analogously, as the velocity is reduced below the speed of light, the Lorentz factor reduces dramatically. The Lorentz factor impacts the radius of orbit of the beam, and also the synchrotron radiation generated from it. As we see, reducing the particle velocity reduces the Lorentz factor which dramatically reduces the device radius and synchrotron radiation. The reduction in size and radiation makes the device economical, scalable, portable and high efficiency. 332 shows the change in Lorentz factor with velocity of particle numerically. 334 shows the same in a graph.

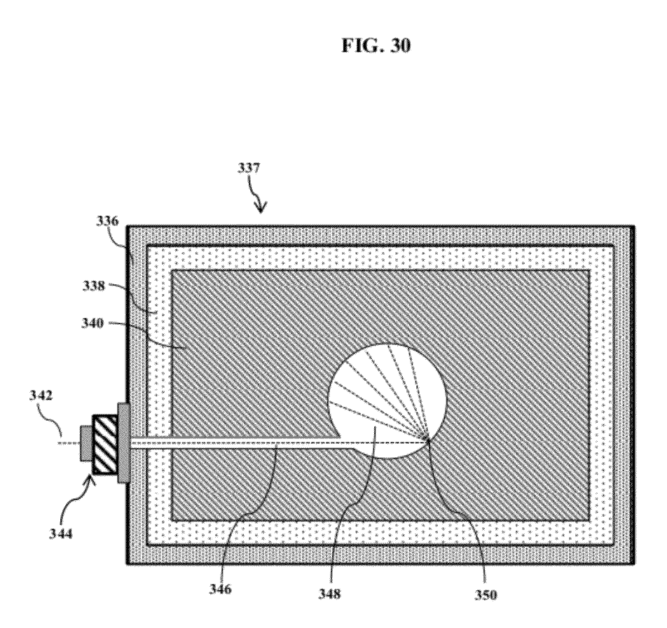

FIG. 30 shows one embodiment of the beam catchment block, wherein the beam can be destroyed when the equipment is disturbed, to prevent the leakage of the stored energy into the environment. FIG. 30 shows a cross-section view of the device. The catchment block 337 consists of a hard, high durability external shell 336, a secondary radiation absorbing shell 338 and the solid high density catchment core 340 made of some very high density material such as lead. The catchment core contains a beam dispersion cavity 348. When the device sensors detect any threat to the integrity and safety of the device, they activate the beam deflectors on the storage ring and deflect the beam into the catchment block. The beam 342 (all beamlets in beam), enter the catchment block through the injection channel 344, and reach the beam dispersion cavity 348 traveling through the beam pathway 346 which is a hole in the core that allows the beam to travel to the beam dispersion cavity. The beam strikes the dispersion cavity 348 at point 350. On contact most of the beam particles embed themselves in the catchment core 340, while others ricochet off the surface and disperse to other locations in the catchment core. Eventually, all particles embed themselves in the catchment core and the beam is destroyed. The collision between the beam particles and the catchment core can cause radioactivity to be induced in the catchment core. Therefore, the block needs very strong insulation and multiple layers of protection to hold all particles from the beam within itself and any emerging radioactivity. The catchment block in any one unit of the device will only be used once at most and ideally never. Once it is used, the device is de-activated, and the catchment block removed and disposed off.

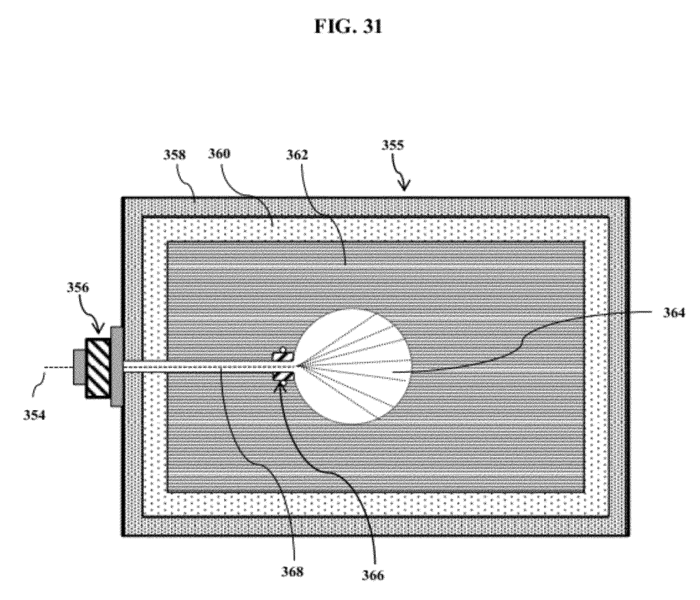

FIG. 31 shows another embodiment of the beam catchment block, wherein the beam can be destroyed when the equipment is disturbed, to prevent the leakage of the stored energy into the environment. The beam catchment block 355 consists of a hard, high durability external shell 358, a secondary radiation absorbing shell 360 and the solid high density catchment core 362 made of some very high density material such as lead. The core 362 contains a beam dispersion cavity 364, and injection channel 356. In addition, in this design we have a set of de-focusing magnets 366 at the entry point to the beam dispersion cavity. The beam 354 enters through 356, and travels through 368. The de-focusing magnets 366 cause the beam to spread in space by applying a de-focusing magnetic field. When the beam 354 crosses 366 it spreads out and strikes the beam catchment cavity in many different points. The particles of the beam embed themselves in the catchment core 362 and the beam is destroyed.

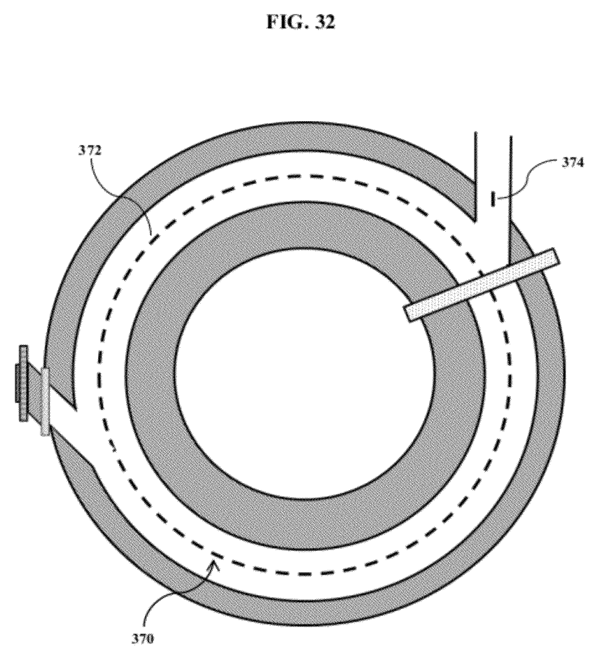

FIG. 32 shows beamlets as part of the larger beam, to clarify the structure of the beam. The beam 370 consists of many individual beamlets (bunches) such as 372. Each beamlet is spatially separated from every other beamlet so that no two beamlets every collide with each other. The control systems of the device are set up such that every injected beamlet is inserted precisely into a vacant segment on the beam path. When energy needs to be extracted, a beamlet such as 374 is extracted and injected into the energy reconversion unit while no other beamlet is disturbed.

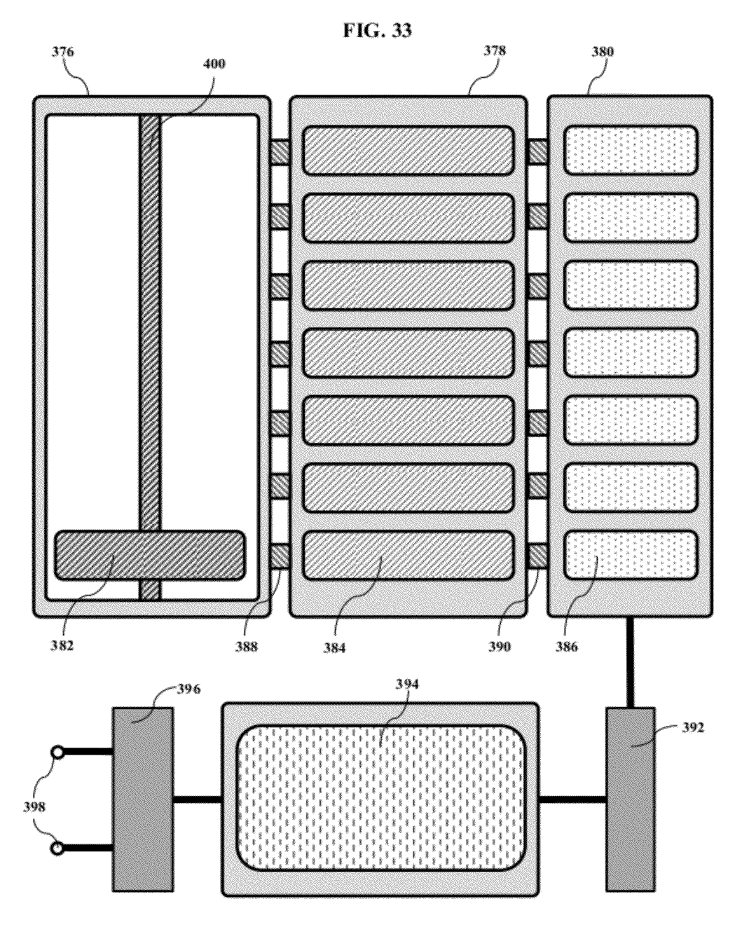

FIG. 33 shows a highly simplified view of an operational grid level system implementing the present invention to store energy on the electrical grid. The system consists of accelerator ring unit 376, a storage ring stack 378, a reconversion unit stack 380, a conventional energy storage interface 392, conventional temporary storage 394, grid interface 396 and finally grid interconnects 398. The accelerator unit consists of an accelerator ring 382 mounted on a vertical lift 400. The storage stack 378 consists of many storage rings such as 384. The reconversion unit stack consists of many energy reconversion units such as 386. The accelerator ring 382 accelerates particles and transfers them to storage rings such as 384 in storage stack 378 via transfer channels such as 388. Storage stack 378 holds very large amounts of energy in a very small volume of space and mass. When energy needs to be returned to the grid, beamlets are extracted from the storage rings and sent to the reconversion units such as 386 in reconversion stack 380 via extraction channels such as 390. The reconversion units convert the KE of beamlets to electricity, which is stored temporarily in the conventional storage 394. Conventional storage interface 392 modulates the flow of current from reconversion stack to the conventional storage 394. Finally, the energy is returned to grid, via interconnects 398. The supply of power from the conventional storage is modulated by the grid interface 396.

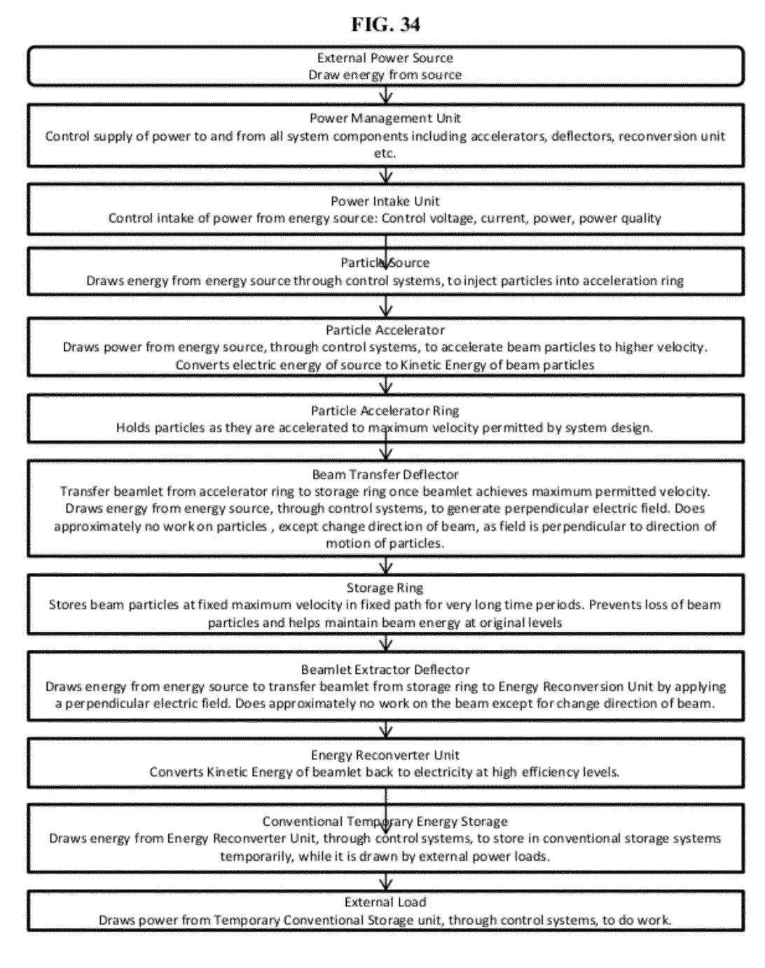

FIG. 34 shows the energy flow in the present invention, from the intake of energy from external source to its return to an external load.

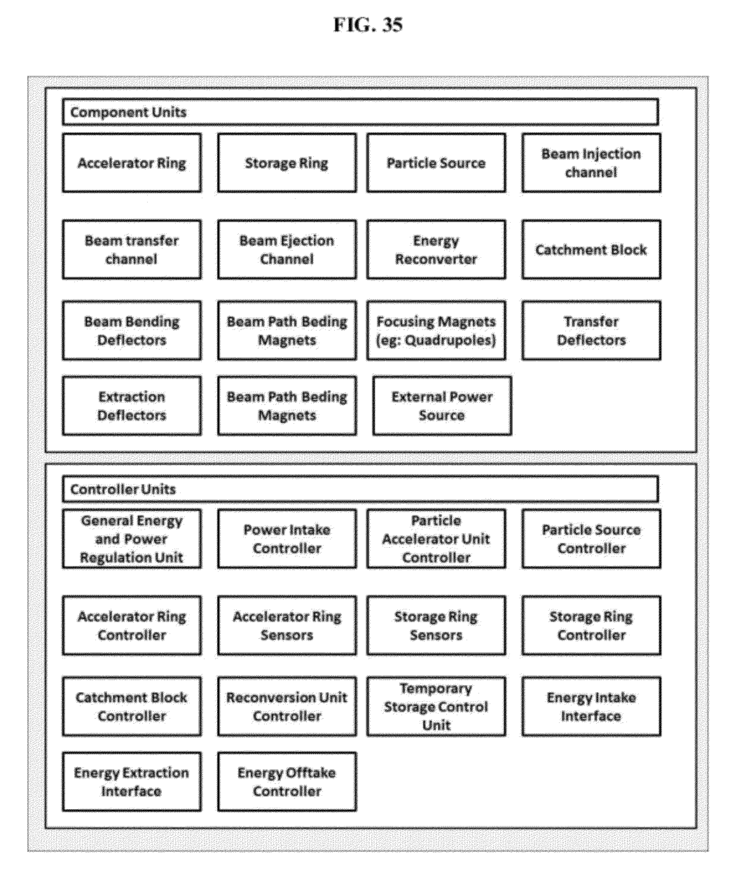

FIG. 35 shows the system level design breakdown of one embodiment of the present invention, showing the various components of the system.

### Advantages

Advantages of present invention:
a. Enormous energy densities are achievable. Energy densities in terms of Joules/kg and Joules/m³ can be extremely high. Energy density is only limited by number of particles that the device can hold in accelerated state and maximum velocity to which the particles can be accelerated.
b. High energy density means small size and low weight, which allows for wide set of applications.
c. Very favorable charge-discharge ratio—System can be charged up to store energy very rapidly, and energy can be drawn from the system very fast as well.
d. Very long lifecycle—Since there are few parts that degrade over time, the device can last a very long time, unlike batteries that usually need to be discarded after a few thousand charge-discharge cycles.
e. Can be manufactured for low cost and in large scale. All required components are easily available and already manufactured at scale for various applications.
f. Various form factors possible. Form factor of device can be modified according to requirements of application, both in shape and size.
g. Usable across many applications:
   i. Utility level storage—store grid electricity during periods of excess supply, discharge during periods of excess demand.
   ii. Vehicular storage—replace gasoline in cars, buses, trucks etc.
   iii. Portable electronic device energy storage—replace batteries in laptops, cellphones, cameras etc.
   iv. Power quality improvement—store and discharge in short cycles to improve quality of power delivered on the grid.
h. No environmental impact—doesn't produce emissions like hydrocarbons, doesn't require large land areas like pumped hydro or compressed air energy storage (CAES).
i. Potentially high efficiency—very high percentage of energy consumed during charge-up can be recovered during discharge if all components properly designed.
j. Flexible power delivery—can deliver any rated power output as required. Again, determined by rate at which particles are removed from beam.
k. Separation of storage and power. Each can be modified independent of the other.
l. Scalability: Possible to cover entire spectrum from Grid Level storage to automobiles to portable electronic devices. Safety: Very safe. In case of emergency, beam can be destroyed within the device in thousands of a second to prevent any leakage into environment. Non-chemical nature of device precludes explosions, leakage and environmental damage.

### Other Considerations

Synchrotron Radiation losses: When charged particles are accelerated through magnetic fields at high velocities, they give out radiation called synchrotron radiation. Synchrotron radiation represents a loss of energy from the particles therefore it is necessary to minimize the synchrotron radiation so as to minimize energy loss in present invention. Synchrotron radiation is proportional to the fourth power of the velocity of the particle (and approximately eighth factor of velocity when the Lorentz factor γ is taken into consideration) therefore accelerating particles to slightly lower velocities helps reduce synchrotron radiation considerably.
Power loss from synchrotron radiation is given by:

$$P = \frac{2 {Ke}^{2} {γ}^{4} {v}^{4}}{3 {c}^{3} {r}^{2}} watts$$

For a proton accelerated to 1/10 speed of light, in a magnetic field of B=1 tesla, and radius of orbit of 0.3 meters, we get:
P=3.16×10⁻²³ watts
The proton with the given velocity would start with energy of about 7.2×10⁻¹³ J.
Over the course of a year, we have about 3.15×10⁷ seconds. Therefore, energy lost over the course of a year would be approximately:

E_{L}=P×t=3.16×10⁻²³×3.15×10⁷=9.95×10⁻¹⁶ J=10⁻¹⁵ J (approx.)
As a percentage of total starting energy, this would be approximately 10⁻¹⁵/10⁻¹³=10⁻²=1% (approx.)
Therefore, we get approximately 1% energy loss per year from synchrotron radiation. However, this number would be orders of magnitude larger if we accelerate particles to higher velocities closer to c and much smaller if we accelerate particles to velocities lower than 0.1 c.

Indicative Device Dimensions

The numbers below are one example of system design and capacity. In other embodiments the actual design, dimensions and capacity could vary considerably.

### Standard Design

Particle: Proton
Velocity: 3×10⁷ m/s (0.1 c)
Rest mass: 1.6×10⁻²⁷ kg
Charge: 1.6×10⁻¹⁹ Coulomb
Storage Ring Magnetic Field (B)=1 Tesla
Radius of orbit (r) of accelerated proton at v=3×10⁷ m/s

$$r = \frac{γ mv}{qB}$$

γ for v=3×10⁷ is 1.005

r=(1.005)*(1.6×10⁻²⁷×3×10⁷)/(1.6×10⁻¹⁹×1)=3.015×10⁻¹=0.3015 meters
This gives us an estimate of the radius of the accelerator ring 030 and storage ring 048 of the present invention. Therefore, we can hold a proton accelerated to 0.1 c in a ring of radius about 0.3 meters with a magnetic field of 1 Tesla.

$$\begin{matrix}Kinetic Energy of accelerated proton = m {c}^{2} ( γ - 1 ) ⇒ E \\ = m {c}^{2} ( \frac{1}{\sqrt{1 - {( v / c )}^{2}}} - 1 )\end{matrix}$$

$$\begin{matrix}γ - 1 = ( \{ 1 / sqrt [ 1 - {( v / c )}^{2} ] \} - 1 ) \\ = ( \{ 1 / ( sqrt [ 1 - {( 0.1 c / c )}^{2} ] \} - 1 ) \\ = ( \{ 1 / ( sqrt [ 1 - {( 0.1 )}^{2} ] \} - 1 ) \\ = ( \{ 1 / ( sqrt [ 1 - 0.01 ] \} - 1 ) \\ = ( \{ 1 / ( sqrt [ 0.99 ] \} - 1 ) \\ = ( \{ 1 / 0.995 \} - 1 ) \\ = 0.005 / 0.995 \\ = 0.005 ( approx . ) \\ = 5 \times {10}^{- 3}\end{matrix}$$

E=mc²(γ−1)=1.6×10⁻²⁷×(3×10⁸)²×5×10⁻³=8×10⁻³⁰×9×10¹⁶=72×10⁻¹⁴=7.2×10⁻¹³ J
In electron volts=7.2×10⁻¹³/1.6×10⁻¹⁹=4.5×10⁶ eV=4.5 MeV
In order to store 1 MWHr in the device, we need following amount of total energy across all accelerated particles: 1 MWHr=3.6×10⁹ Joules.
Therefore, number of required particles=3.6×10⁹/7.2×10⁻¹³=0.5×10²²=5×10²¹ protons.
Given one proton has mass 1.6×10⁻²⁷ kg=>total mass of protons required for 1 MWHr energy storage=1.6×10⁻²⁷×5×10²¹=8×10⁻⁶ kg=8×10⁻³ crams (about 8 milligrams)
Most electric cars (such as Nissan Leaf) consume 34 KWHrs every 100 miles as of year 2011.
The present invention can store 1 MWhr with above specifications which implies about 3000 mile range on one full charge of the device.
Summary of specifications for a standard implementation of current invention:
Accelerated Particles=Protons
Radius of device=0.3 meters (approx.)
Energy per proton=4.5 MeV
Number of protons=5×10²¹ particles
Combined Mass of accelerated protons=8×10⁻⁶ kg
Total energy storage capacity=1 MWhr
The table below shows the energy storage capacity of the device at different levels of velocity and number of accelerated particles.

| Energy | v = 3 × 10⁶ m/s | | | |
|---|---|---|---|---|
| (KWHrs) | (0.01 c) | | v = 3 × 10⁷ m/s (0.1 c) | |
| N = 5 × 10¹⁹ | 0.1 | | 10 | |
| N = 5 × 10²¹ | 10 | | 1000 | (1 MWhr) |
| N = 5 × 10²³ | 1000 | (1 MWhr) | 100,000 | (100 MWhr) |

1. An apparatus for storing energy comprising one or more of:
a particle acceleration ring for accelerating particles to high velocities
an accelerated particle storage ring for storing accelerated particles at high velocities in orbits at fixed velocity and energy
a particle source which produces particles for acceleration and injects them into the particle acceleration ring
particle accelerator unit in the particle acceleration ring which uses energy supplied from an external source to accelerate particles to high velocities
an acceleration ring particle deflector which deflects particles from the acceleration ring into the storage ring when the particle have achieved maximum allowable velocity
a particle transfer channel that transfers particles from the acceleration ring to the storage ring
a storage ring particle defector that deflects particles out of their closed loop orbit inside the storage ring into the ejection channel
a particle ejection channel which guides the ejected particles out of the storage ring and into the energy reconversion unit
an energy reconversion unit that converts the kinetic energy of the accelerated particles from the storage ring to electricity (potential energy) which powers an external load
a catchment block particle deflector that redirects the beam into the catchment block when structural integrity of device is threatened
a beam catchment block that absorbs the beam and destroys it to prevent leakage into the environment

2. Apparatus according to claim 1, wherein an external energy source is provided that provides energy to both the particle acceleration component and particle source component and possibly the particle deflectors

3. Apparatus according to claim 1, wherein an external conventional temporary storage device such as a battery is provided which is linked to the energy reconversion unit and is charged up by the energy reconversion unit and is used to delivery energy to an external load in an easily usable form

4. Apparatus according to claim 1, wherein the acceleration ring consists of a particle acceleration cavity or pipe which consists of a vacuum within which charged particles are accelerated

5. Apparatus according to claim 1, wherein the storage ring consists of an accelerated particle storage cavity or pipe which consists of a vacuum within which charged accelerated particles are held in continuous closed loop circulation

6. Apparatus according to claim 1, wherein the said particle can be any of various different types of particles such as protons, electrons, ions of heavier elements or other particles, generally carrying a net positive or negative charge

7. Apparatus according to claim 1 wherein the particles can be engineered macro-particles specifically designed for the device in claim 1 in order to maximize the performance of the device in claim 1 on various parameters such as energy density, beam lifetime, device lifetime cost, full cycle energy efficiency among others and could be constructed as charge carrying nano-particles such as charged fullerenes in one embodiment

8. Apparatus according to claim 1, wherein said particles are accelerated by the accelerator component in the acceleration ring which draws power from the said external power source and using one of various methods such as RF microwaves or alternating electric fields applies force on the said particles driving them to a higher velocity and thereby increasing their kinetic energy

9. Apparatus according to claim 1, wherein the said particles are accelerated to very high velocities in the range of less than 1% to 99.99% the speed of light such as to maximize the total beam energy while reducing energy per particle thereby reducing the beam orbit radius, device size and device cost as well as reducing the energy losses from the beam while maximizing the total energy of the particle beam

10. Apparatus according to claim 1, wherein the said particles are injected into the acceleration ring in batches of very large number of particles by the said particle source with all particles in a given batch being of exactly same mass and type and carrying exactly the same velocity when they reach the accelerator component

11. Apparatus according to claim 1 wherein the design of the device is such that it is scalable, portable, and economical and fit for commercial use

12. Apparatus according to claim 1, wherein magnets are placed around the said acceleration and storage rings to create a magnetic field which forces the accelerated charged particles to move in a circular orbit

13. Apparatus according to claim 1, wherein electric field deflectors are placed at various points in the beam path to bend the beam and force the accelerated charged particles to move in a closed loop path which might be quasi-circular or polygonal

14. Apparatus according to claim 1, wherein the strength of magnets used for bending the beam can be varied along a range of values and controlled to change the effective magnetic field according to requirements, such as increasing the magnetic field as the velocity of the particles increases so as to hold them in an orbit of fixed radius

15. Apparatus according to claim 1, wherein the kinetic energy stored in the beam and therefore the device of claim 1 is given by the relativistic kinetic energy formula
$$E = m {c}^{2} ( \frac{1}{\sqrt{1 - {( v / c )}^{2}}} - 1 ) * N$$
Where, ‘m’ is the mass of a single accelerated particles, ‘c’ is the speed of light (3×10⁸ m/s), v is the velocity to which the particle is accelerated and N is total number of particles in the circulating beam

16. Apparatus according to claim 1, wherein the specific design of the apparatus can be modified within the scope of the present invention while retaining the primary concept of storing energy in the kinetic energy of highly accelerated charged particles which are nevertheless accelerated to velocities substantially lower than the speed of light, such that beam energy and not energy per particle is maximized, and such that total device energy storage capacity, energy density, size and cost is appropriate for applications such as grid energy storage and automobile energy storage

17. Apparatus according to claim 1, wherein the specifications of the design of the apparatus such as radius of rings, magnetic field strength of magnets, power of the accelerator component among others can be modified according to requirements

18. Apparatus according to claim 1, wherein the objective of the present invention is to draw energy from the said external power source, store it for time periods ranging from seconds to thousands of hours without energy loss, or with trivial energy loss, and make it available in an easily usable form to an external load at a later point of time

19. Apparatus according to claim 1, wherein the energy delivered to the external load is almost same as the energy drawn from the external energy source, so that energy losses are very small

20. Apparatus according to claim 1, wherein the design of the energy reconversion unit can be considerably modified within the scope of the present invention

21. Apparatus according to claim 1, wherein the design of the apparatus allows for the separation of the acceleration ring and storage ring, wherein the storage ring along with the energy reconversion unit form one block and the rest of the apparatus forms another block, and only the block with the storage ring is distributed to different locations and platforms where it is required to deliver energy, while the acceleration ring block is held within recharging locations and platforms, wherein it is connected to the storage ring block only when recharge is required, after which the two are disconnected as the storage ring is filled with energy of accelerated particles, and the acceleration ring is no longer required

22. Apparatus according to claim 1, which allows for very high energy densities (Joules/kg, Joules/m³), rapid charge-discharge cycles, very limited environmental impact, very high energy efficiency (energy recovered/energy consumed), low cost of manufacturing, possibility of large scale manufacturing and considerable flexibility with respect to size and form factor

23. Apparatus according to claim 1, wherein the path traced by the accelerated particle beam in the acceleration ring and storage ring may be any closed loop path including circular, polygonal or toroidal

24. Apparatus according to claim 1, wherein various configurations of bending and focusing magnets along the beam path are possible

25. Apparatus according to claim 1, wherein the accelerator and storage rings contain various sensors and controllers to control the beam and the performance of the device

26. Apparatus according to claim 1, wherein the energy stored in the device is recovered in a staged manner, starting with the reconversion of kinetic energy to electrical energy, followed by the storage of the electric energy in a conventional temporary storage device such as a battery, followed by the drawdown of the energy stored in the conventional device by an external load

27. Apparatus according to claim 1, wherein a beam catchment block is provided where the beam can be destroyed by shooting the beam into a high density core such as a lead block, when the structural integrity of the device is threatened

28. Apparatus according to claim 1, wherein an electric field deflector is provided which applies an electric across the path of the beam to bend it and redirect it in particular directions as required and can be switched on and off as needed and whose bending strength can be varied

29. Apparatus according to claim 1, wherein various configurations of electric field deflectors for bending and redirecting the beam can be possible in combination with or independent of bending and focusing magnets

30. An apparatus for focusing a charged particle beam within a beam pipe by wrapping the beam pipe within a uniformly charged material, which exerts a cylindrically inward focused electric field on the beam driving any stray beam particles back into the beam

31. An apparatus according to claim 30, wherein the proposed apparatus can be implemented as another pipe or a hollow cylinder, each uniformly charged across its volume

32. An apparatus according to claim 30, wherein the electric field exerted by the apparatus is uniform across each line parallel to the pipe, but increases in intensity closer to the walls of the pipe and is weakest within the pipe at the points farthest from the walls of the pipe

33. An apparatus according to claim 30, wherein the charged particles in the beam are pushed to the lowest field intensity region by the uniform electric field exerted by the apparatus

34. An apparatus according to claim 30, wherein, the apparatus can act as a replacement for beam focusing magnet configurations such as quadrupole magnets

35. An apparatus for reconversion of kinetic energy of the charged particle beam, wherein the kinetic energy is reconverted through ionization of a charge-neutral fluid

36. An apparatus according to claim 35, wherein the accelerated particle beam is shot into an ionization chamber containing fluid which is susceptible to ionization through mechanical collisions with other particles

37. An apparatus according to claim 35, wherein the fluid in the ionization chamber is ionized by the accelerated particle beam when the beam is shot into the ionization chamber in such as manner that almost all the kinetic energy of the accelerated particle beam is consumed in the process of ionizing the fluid

38. An apparatus according to claim 35, wherein the ions generated from ionization of the fluid are driven towards separate ends of the ionization chamber through methods such as application of a small electric field resulting in the formation of electric potential difference between the two ends of the ionization chamber

39. An apparatus according to claim 35, wherein the potential difference between the two ends of the ionization chamber holding the oppositely charged ions causes current to flow between the two ends when they are connected through a conductor such as a metal wire

40. An apparatus according to claim 35, wherein the total energy stored in the electric potential difference between the two ends of the ionization chamber holding the oppositely charged ions is not significantly less than the kinetic energy of the accelerated particle beam that caused the initial ionization in the fluid

41. An apparatus for reconversion of kinetic energy of the charged particle beam, wherein the kinetic energy is reconverted through direct induction of current utilizing the principle of induction of current due to time varying magnetic fields also known as Faraday's law

42. An apparatus according to claim 41, wherein the reconversion device consists of a charged beam storage ring like system with dipole magnets or electric field particle deflectors to hold the charged particle beam in closed loop path or a spiral path with reducing radius

43. An apparatus according to claim 41, wherein the device contains a circular or polygonal disc shaped vacuum cavity where the charged particle beam is injected and where it traces a closed loop path under the influence of an external magnetic field or electric field deflectors

44. An apparatus according to claim 41, wherein induction discs are placed just above and below the vacuum cavity of the device

45. An apparatus according to claim 41, wherein the induction discs consist of a very large number of small metal windings placed all through the volume of the induction discs, insulated from each other, networked together in parallel in a single circuit and held within the structure of induction discs

46. An apparatus according to claim 41, wherein the motion of the charged particle beam through the vacuum cavity of the device causes magnetic flux naturally generated by the charged particle beam to pass through the metal windings of the induction disc in a time varying manner thereby inducing flow of current in the metal windings which current is drawn out of the device through the circuit to which the metal windings are connected

47. An apparatus according to claim 41, wherein the total energy drawn from the device through the induction of current in the metal windings is substantially equal to the total kinetic energy of the charged particle beam at time of its entry into the device

48. An apparatus for reconversion of kinetic energy of the charged particle beam, wherein the kinetic energy is reconverted through the utilization of the principle of conservation of momentum

49. An apparatus according to claim 48, wherein the energy reconversion device consists at a minimum of a spinning wheel attached to a generator and a wheel stabilizing system through axles or shafts

50. An apparatus according to claim 48, wherein the spinning wheel is designed so as to capture the charged particles shot at its edge surface and prevent them from ricocheting off its surface, wherein the edge surface is the surface of the wheel swept by a line parallel to the axis of the wheel rotating about the axis

51. An apparatus according to claim 48, wherein the charged particle beam is directed at the edge surface of the spinning wheel at an intersection tangent to the surface

52. An apparatus according to claim 48, wherein the accelerated particles are captured by the edge surface of the spinning wheel when the particles come into contact with it, a requirement that can be accomplished by methods such charging the edge surface with a charge opposite to the charge of particles in the beam

53. An apparatus according to claim 48, wherein the linear momentum of the charged particle beam causes the wheel to start spinning when the accelerated particles are captured by the surface of the wheel and the linear momentum of the particle beam converts to the angular momentum of the spinning wheel

54. An apparatus according to claim 48, wherein the angular momentum of the spinning wheel is substantially equal to the linear momentum of the particle beam prior to contact and therefore the total energy in the spinning wheel is substantially equal to the kinetic energy of the particle beam

55. An apparatus according to claim 48, wherein the spinning wheel drives the shaft of a generator connected to its axis of motion, wherein electricity is generated in the generator by the spinning shaft

56. An apparatus according to claim 48, wherein the total energy generated by the generator is substantially equal to the total kinetic energy of the particle beam that causes the wheel to spin

57. An apparatus for reconversion of kinetic energy of the charged particle beam, wherein the kinetic energy is reconverted through the mechanical ejection of electrons from the surface of solid plates such as metal plates

58. An apparatus according to claim 57, wherein the device consists of a series of plates of a material such as a metal or graphene which has a high tendency to eject electrons on mechanical contact

59. An apparatus according to claim 57, wherein the electron ejection plates are placed in parallel to each other and at an angle to the direction of motion of the beam with small gaps between the plates such that when the beam strikes one plate and ricochets off its surface, it strikes the opposing plate where it again ricochets to strike the first plate again

60. An apparatus according to claim 57, wherein each collision of the beam particles with the electron ejection plates causes electrons to be ejected from the surface of the plates

61. An apparatus according to claim 57, wherein the plates are connected to a circuit such that the electrons ejected from the surface of the plates are drawn out of the device in the form of current by the circuit

62. An apparatus according to claim 57, wherein the total energy generated through the generation of an electric current from the plates is substantially equal to the kinetic energy of the accelerated particle beam at the time it enters the device

63. An apparatus for reconversion of kinetic energy of the charged particle beam, wherein the kinetic energy is reconverted through thermal heating of a fluid in a closed chamber

64. An apparatus according to claim 63, wherein the device consists of a minimum of a thermal heating chamber containing fluid, a turbine connected to the heating chamber through pipes and a generator connected to the turbine through a shaft

65. An apparatus according to claim 63, wherein the particles of the fluid in the thermal heating chamber are too large to exit through the beam injection channel thereby allowing the maintenance of vacuum in any device connecting to this device through the beam injection channel

66. An apparatus according to claim 63, wherein the accelerated particle beam is injected into the thermal heating chamber wherein it strikes the particles of the fluid causing the fluid to heat up substantially from its original temperature as the kinetic energy of the particle beam is converted to heat energy of the fluid

67. An apparatus according to claim 63, wherein the heated fluid in the heating chamber expands due to the heating and is allowed to pass through a pipe to a turbine where it drives the turbine which in turn drives the shaft of a generator causing it to generate electricity

68. An apparatus according to claim 63, wherein the heated fluid loses energy after passing through the turbine, cools down and is allowed to re-enter the heating chamber

69. An apparatus according to claim 63, wherein the energy generated by the generator as electricity is substantially equal to the kinetic energy of the particle beam injected into the thermal heating chamber
